(19) United States
(12) Patent Application Publication
(10) Pub. No.: US 2004/0073472 A1
(43) Pub. Date: Apr. 15, 2004

(54) Method and system for supply-and-demand plan planning

(76) Inventors: Toshiyuki Sakuma, Kawasaki (JP); Tazu Nomoto, Yokohama (JP); Mitsuhiro Enomoto, Kamakura (JP); Masahiro Sato, Yokohama (JP); Katsuya Ishitomi, Tokyo (JP); Hideyuki Sasaki, Fujisawa (JP); Kimitaka Tamura, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/642,685

(22) Filed: Aug. 19, 2003

(30) Foreign Application Priority Data
Sep. 4, 2002 (JP) 2002-259464

(51) Int. Cl. G06F 17/60

(52) U.S. Cl. 705/8

(57) ABSTRACT

Techniques are provided which can easily and quickly make a supply-and-demand plan relative to demand. A processing device compares at each time point given demand with a manufacture capacity at a site stored in a storage device. If a supply disabled item exists, the number of supply disabled items and a time point when a supply becomes disabled are derived, and the number of supply disabled items and the time point are stored in the storage device as information representative of a supply disabled reason. A list of planned demand at each of a plurality of proceeding periods, a corresponding supply plan proposal, the site where a supply disabled state occurs, and information representative of a quantity is displayed on a display device. In addition, the site where the supply disabled state occurs and a supply disabled quantity in the period during which the supply disabled state occurs are displayed.

### BACKGROUND OF THE INVENTION

The present invention relates to planning of supply relative to demand for products, i.e., techniques of making a supply-and-demand plan. More specifically, the invention provides techniques of making a supply-and-demand plan capable of easily reconsidering a supply plan if an appointed delivery time cannot be allocated.

Generally, a supply-and-demand plan is made at a manufacture site such as a factory where products are manufactured. The supply-and-demand plan is made in order to ship products before an appointed delivery time to respond given product demand. Supply-and-demand planning makes a product supply plan and determines a delivery time by performing an allocation process of allocating for planned demand about a manufacture capacity, a inventory, an available component provision quantity, respectively at a manufacture site. If the calculated delivery time allocates an appointed delivery time, an order of the demand is received. Alternatively, the allocate process is performed based upon an appointed delivery time, and if all demand can be allocated before the appointed delivery time, it is judged that supply is possible. If all demand cannot be allocated before the appointed delivery time, it is judged that supply is difficult. In either case, if supply for demand is difficult before an appointed delivery time, i.e., if shipment cannot be made before the appointed delivery time, the following countermeasures are performed. Supply for demand is abandoned, a remaining manufacture capacity at a manufacture site, i.e., an increase of an overtime work, and the like are reconsidered, a delay of delivery is negotiated with an orderer, and the like.

It is not easy to determine which one of such countermeasures is to be selected, because a very large number of factors are associated with making a supply-and-demand plan. For example, this plan is related with a manufacture capacity, a inventory and the like at a manufacture site, other products, a replenishment site of components and the like, a circulation site for delivery, and the like. From this reason, the allocation process for making a supply-and-demand plan becomes a very complicated process. If a supply-and-demand plan cannot allocate an appointed delivery time, it is, therefore, not always easy to find the reason and adopt a countermeasure for this reason. If the reason cannot be found, a supply-and-demand planner has conventionally negotiated with managers at a plurality of operating sites such as sales sites and manufacture sites to adjust scheduling and allocate demand. This impose a large amount of works upon an operating manager at each site.

### SUMMARY OF THE INVENTION

Under such circumstances, it has been desired to provide techniques of easily and quickly making a supply-and-demand plan for given demand for goods.

A concept of the invention is to provide such techniques.

In order to realize this, the invention provides a supply-and-demand plan making method of making a supply plan for a manufacture site capable of manufacturing a plurality of items, the supply plan realizing a supply of each item by satisfying a delivery time for planned demand, the method comprising steps of:

comparing a pre-stored manufacture capacity at the site with given demand at each time point, and if a supply disabled item exists, deriving the number of supply disabled items and a time point when a supply becomes disabled and storing the number of supply disabled items and the time point in a storage device as information representative of a supply disabled reason;

displaying, on a display device as a list, planned demand at each of a plurality of proceeding periods, a corresponding supply plan proposal, the site where a supply disabled state occurs, and information representative of a quantity, and displaying the site where the supply disabled state occurs and a supply disabled quantity in the period during which the supply disabled state occurs; and

receiving an external instruction of displaying the supply disabled quantity and displaying information identifying an item constituting the supply disabled quantity and information on a requested delivery time, a requested quantity and a supply quantity respectively of the item.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing an example of the functional structure of a supply-and-demand planning system according to an embodiment of the invention.

FIG. 2 is a block diagram showing a hardware system structure realizing the supply-and-demand planning system of the invention.

FIG. 3 is a schematic diagram illustrating a data map of a data storage unit storing various data used by the supply-and-demand planning system of the invention.

FIG. 4 is a schematic diagram illustrating a code map of a code storage unit storing various codes used by the supply-and-demand planning system of the invention.

FIG. 5 is a diagram showing various processing units of the embodiment and their data flow.

FIG. 6 is a diagram showing the transition state among display screens of the embodiment.

FIG. 7 is a diagram showing an example of a main screen of the display device of the embodiment.

FIG. 8 is a diagram showing the display contents of a first sub-screen selected by the main screen.

FIG. 9 is a diagram showing the display contents of a second sub-screen selected by the first sub-screen.

FIG. 10 is a diagram showing an example of the screen used for delivery time adjustment.

FIG. 11 is a diagram showing an example of an NG item list screen showing a list of supply disabled items.

FIG. 12 is a diagram showing an example of an NG item detail screen showing the details of supply disabled items.

FIG. 13 is a manufacture load graph showing an example of delaying a manufacture load through delivery time adjustment.

FIG. 14 is a diagram showing an example of a manufacture capacity assignment renewal screen illustrating a process of changing manufacture capacity assignment.

FIG. 15 is a manufacture load graph showing an example of a process of changing a manufacture load.

FIG. 16 is a diagram showing an example of the NG item detail screen showing the details of supply disabled items under the state that a supply disabled site is solved.

FIG. 17 is a diagram showing an example of the display contents after the manufacture preparation allocate in the first sub-screen is reconsidered.

FIG. 18 is a diagram showing an example of the display contents after a safety stock in the second first sub-screen is reconsidered.

FIGS. 19A and 19B are diagrams showing a supply means renewal screen as an example of the process of changing supply means.

FIG. 20 is a manufacture load graph showing an example of delaying the manufacture period through supply means renewal.

FIG. 21 is a diagram showing an example of the NG item detail screen showing the details of supply disabled items in the state that a supply disabled site is solved.

FIG. 22A is a diagram showing an example of a safety stock renewal screen illustrating a process of renewing a safety stock.

FIG. 22B is a diagram showing an example of a safety stock renewal screen illustrating a process of renewing a safety stock.

FIG. 23 is a diagram showing an example of the display contents after the circulation inventory allocation on the first sub-screen is reconsidered.

FIG. 24 is a diagram showing an example of the display contents after the circulation inventory allocate on the first sub-screen is reconsidered.

FIG. 25 is a graph showing an example of a inventory supply-and-demand progress.

FIG. 26 is a graph showing an example of a inventory supply-and-demand progress.

FIG. 27 is a flow chart illustrating a process of displaying the first sub-screen in the supply-and-demand planning system of the embodiment.

FIG. 28 is a flow chart illustrating another process of displaying the first sub-screen in the supply-and-demand planning system of the embodiment.

FIG. 29 is a flow chart illustrating another process of displaying the second sub-screen in the supply-and-demand planning system of the embodiment.

### BRIEF DESCRIPTION OF THE EMBODIMENTS

Embodiments of the invention will be described with reference to the accompanying drawings. The embodiments will be described by using as an example a supply-and-demand planning system configured as an independent system. The configuration of the invention is not limited only thereto, but the invention can also be implemented partially to a production managing system, a product circulation managing system and the like. The supply-and-demand planning system of the invention may be configured by realizing various functions of the invention to be described later by a plurality of sub-systems distributed via a network.

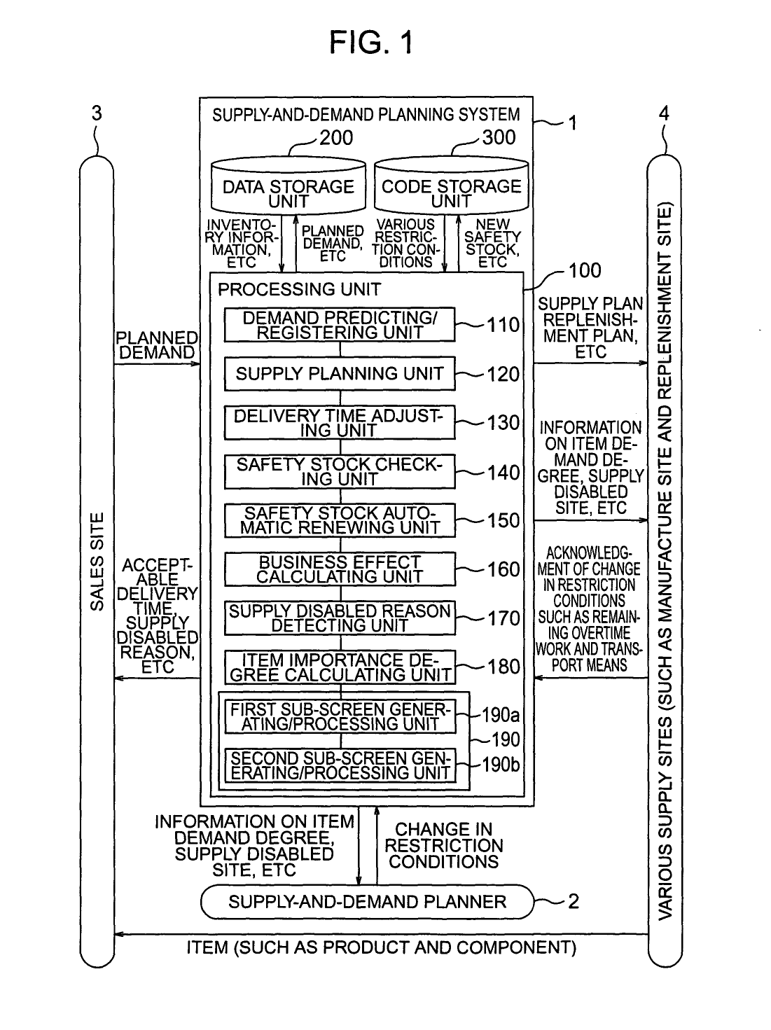

FIG. 1 shows an example of a functional structure of a supply-and-demand planning system according to a first embodiment of the invention. Referring to the supply-and-demand planning system shown in FIG. 1, first a supply-and-demand planner 2 enters a restriction condition change instruction or the like. In response to this, the supply-and-demand planning system executes various processes. Information on an item importance degree, a supply disabled site and the like is supplied to the supply-and-demand planner 2. The supply-and-demand system 1 is connected to a sales site system (hereinafter simply called a sales site) 3 and various supply site systems (hereinafter simply called supply sites) 4 such as a manufacture site and a replenishment site. In response to planned demand from the sales site 4, the supply-and-demand planning system 1 makes a supply-and-demand plan under given restriction conditions. A production plan and a replenishment plan made by the system are presented to the various supply sites 4. Information on the item importance degree, a supply disabled site and the like is provided to the various supply sites 4. The supply-and-demand planning system 1 receives information on acknowledgement of a change in the restriction conditions such as a remaining overtime and transport means, from the various supply sites 4.

The supply-and-demand planning system 1 is constituted of a processor unit 100 for realizing and processing various functions of making a supply-and-demand plan, a data storage unit 200 for storing various data and a code storage unit 300 for storing various codes.

The processor unit 100 has the following functional units for realizing various functions of making a supply-and-demand plan. A demand predicting/registering unit 110 predicts demand which is the premise for making a supply-and-demand plan. A supply planning unit 120 makes a supply plan for demand. A delivery time adjusting unit 130 adjusts a delivery time if the formed supply plan does not allocate the delivery time. A safety stock checking unit 140 checks a safety stock whose quantity is preset at some safety level so as not to form lacking items. A safety stock automatic renewing unit 150 automatically renews the level of the safety stock. A business effectiveness calculating unit 160 performs a process of indicating a business effectiveness of a supply plan. A supply disabled reason detecting unit 170 detects a supply disabled reason if there is a supply disabled state when a supply plan is made. An item importance degree calculating unit 180 calculates the importance degree of each item. A sub-screen generating unit 190 generates a sub-screen on which a planning state is displayed. This sub-screen generating/processing unit 190 generates sub-screens to observer the planning state. The sub-screen generating/processing unit 190 has a first sub-screen generating/processing unit 190a for generating first sub-screen on which a sub-screen supply plan and an associated supply disabled reason are displayed and a second sub-screen generating/processing unit 190b for generating a second sub-screen on which a relation between the item importance degree and the safety stock is displayed.

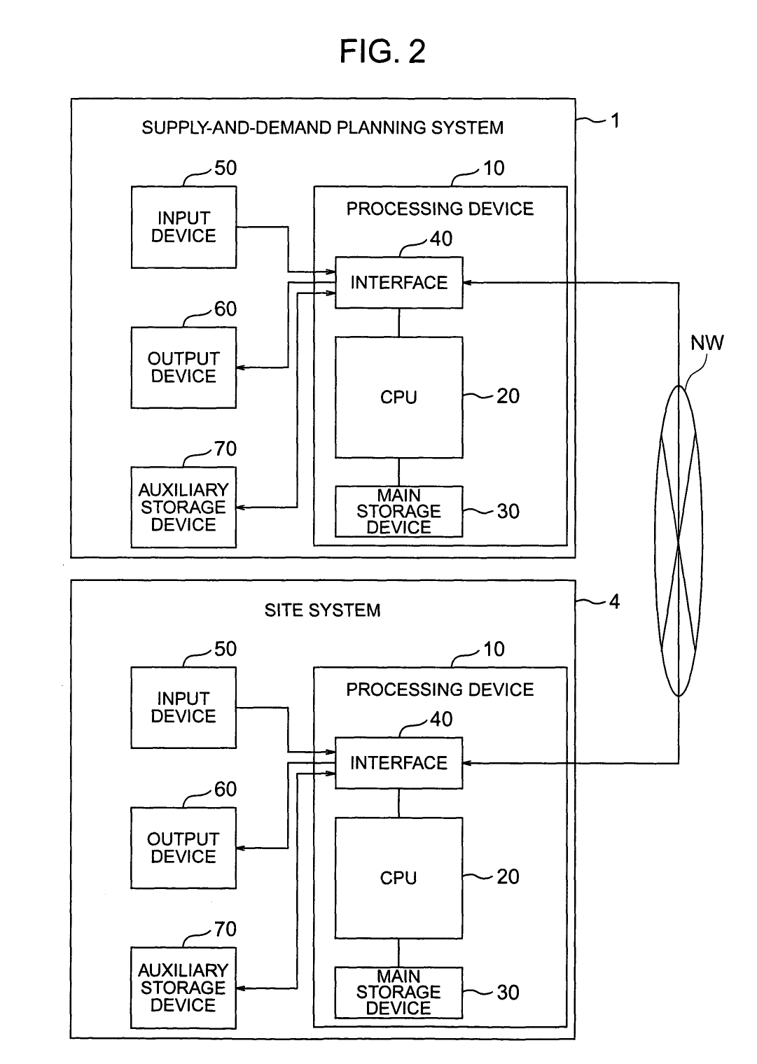

The supply-and-demand planning system 1 of this embodiment is made of a hardware system such as shown in FIG. 2. The system shown in FIG. 2 is structured as a server-client system. A server machine realizes the supply-and-demand planning system 1. Client machines realize supply site systems 4 shown in FIG. 2. Sites configured by client machines include a sales site, a replenishment site, a manufacture site and the like. In this embodiment, the server machine and client machines have the same hardware system. Different hardware systems may be used depending upon the scales and functions of the server and clients. The supply-and-demand planning system 1 and other site systems 4 transfer information via a network system NW such as a local area network, a wide area network and the Internet.

The supply-and-demand planning system 1 has a processing device 10 having a central processing unit (CPU) 20, a main storage device 30 and an interface 40. The supply-and-demand planning system 1 also has an input device 50, an output device 60 and an auxiliary storage device 70 respectively connected via the interface 40. The site system 4 has a similar structure described above. Duplicated description is therefore omitted.

The processing device 10 realizes the functions of the processing unit 100 of the system shown in FIG. 1, the data storage unit 200 and the code storage unit 300. In the system of this kind, various data regarding the manufacture of products is used and the data changes day after day. This data is stored in the auxiliary storage device 70. In the system of this embodiment, when a supply-and-demand plan is made, latest manufacture data is read from the auxiliary storage device 70 and stored in the data storage unit 200 in the main storage device 30. Demand data from the sales site 2 or the like is stored in the auxiliary storage device 70 and read and stored in the data storage unit 200 when a supply-and-demand plan is made.

The processing device 10 realizes the functions of the units 110 to 190 described earlier by making CPU 20 execute a program loaded in a main memory. The program is installed, for example, in the auxiliary storage device 70. The program can be distributed by storing it in a storage medium such as a CD-ROM or via a network, to be installed in the system.

In the system 1, the input device 50 may be a keyboard, a mouse or the like. The output device 60 may be a display, and if necessary, it is provided with a printer. By outputting data to the output device, the supply-and-demand planner 2 can know a planning state of a supply-and-demand plan. The planner can also know the reason why a plan satisfying a delivery time cannot be made. The planner can enter a change in the restriction conditions or the like via the input device.

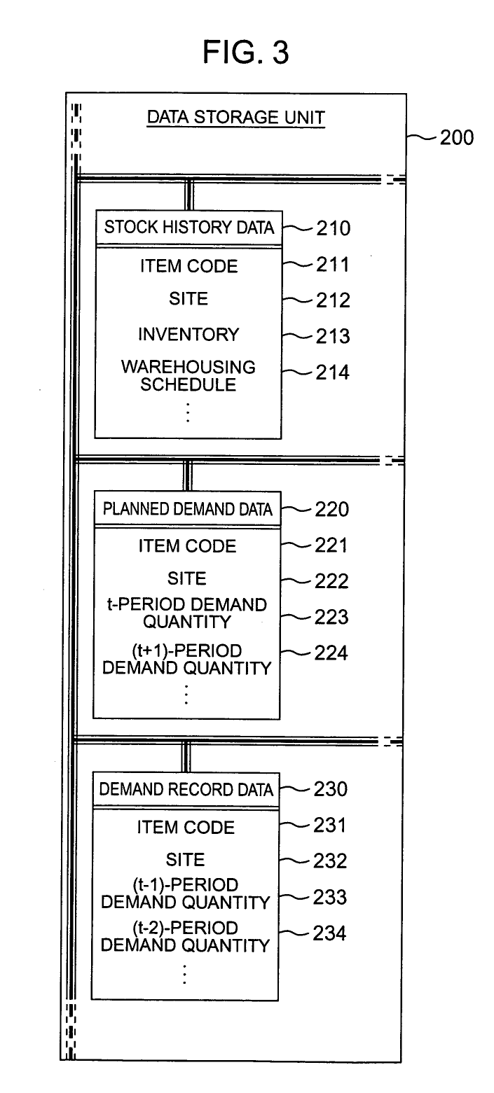

As schematically shown in FIG. 3, the data storage unit 200 stores therein inventory history data 210 representative of a state of the inventory of each item, planned demand data 220 representative of planned demand and demand record data 230 representative of a demand record.

A site 212, an inventory 213, a warehousing schedule 214 and the like are stored as the inventory history data 210 in correspondence with an item code 211 for identifying an item. A demand quantity 223 in a proceeding t period at a site 222, a demand quantity 224 in a t+1 period and the like are stored as the planned demand data 220 in correspondence with an item code 221. A demand quantity 23 in a proceeding t−1 period at a site 233, a demand quantity 234 in a t−2 period and the like are stored as the demand record data 230 in correspondence with an item code 231.

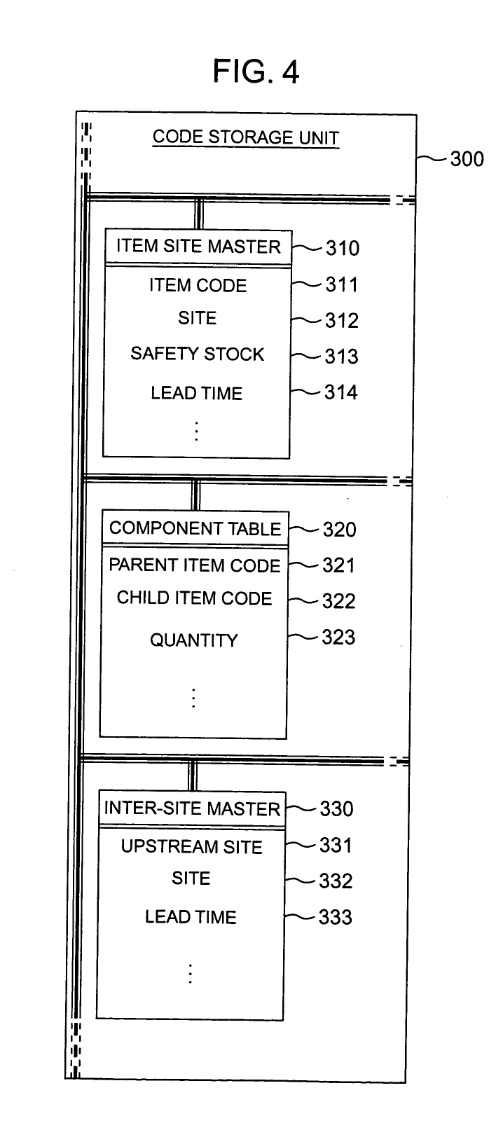

The code storage unit 300 stores information on the restriction conditions of each item of a product. As schematically shown in FIG. 4, the information on the restriction conditions of each item of a product includes an item site master 310 which stores master data such as a safety stock and a lead time of each item at each site, a component table 320 which indicates components constituting a product, an inter-site master 330 which indicates the relative positions of sites, and the like.

A site 312, a safety stock 313, a lead time 314 and the like are stored in the item site master 310 in correspondence with an item code 311 for identifying an item. A parent item code 321 representative of a parent item, a child item code 322 representative of a child item, a quantity 323 and the like are stored in the component table 320. A site 331 at the upstream position of a subject site, the subject site 332, a lead time 333 and the like are stored in the inter-site master 330.

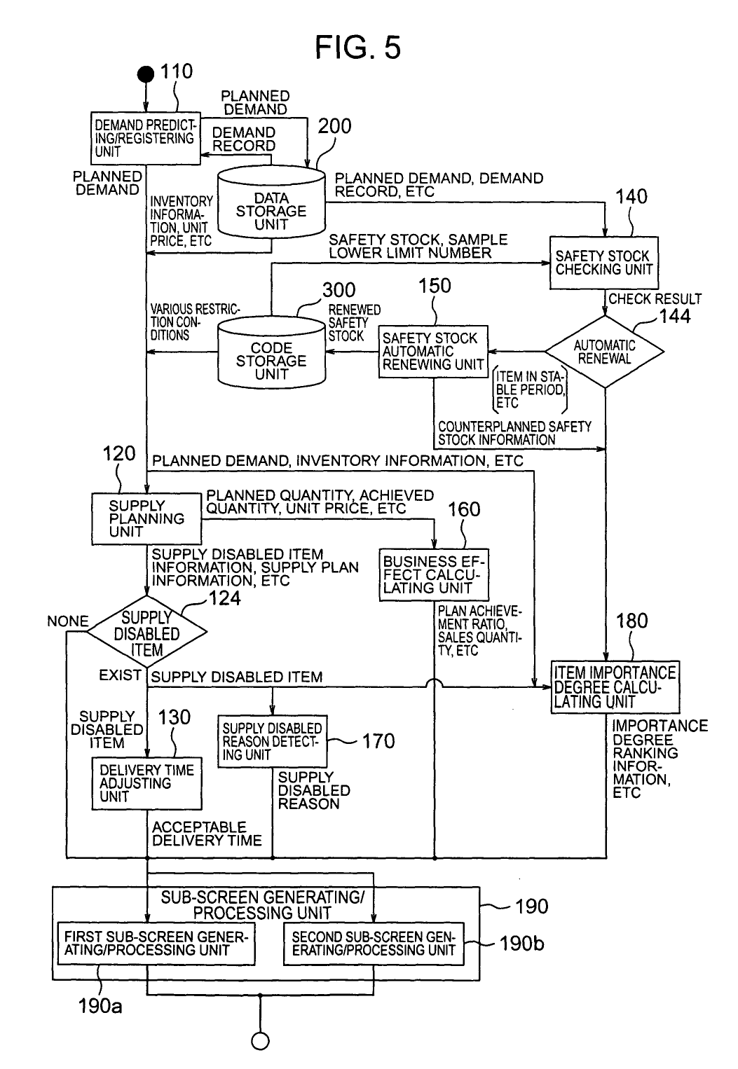

The functions of the units 110 to 190b of the processing unit 100 of this embodiment and information transferred among these units will be described with reference to FIG. 5.

In FIG. 5, each function is disposed along a process flow.

This flow is roughly divided into a process series of generating the first sub-screen and a process series of generating the second sub-screen.

In the process series of generating the first sub-screen, a supply plan is made and various countermeasure processes are performed to deal with a supply disabled state appeared upon making the supply plan. In the process series of generating the second sub-screen, a process of changing the safety stock is performed. In either case, the sub-screen is generated to display a process stage and a process result.

For example, from the sales site 3, planned demand of one or more products intended to be sold at the sales site 3 is sent to the demand predicting/registering unit 110. Information on the planned demand is stored in the date storage unit 200. The data storage unit 200 also stores an actual demand record. The actual demand record is read from the data storage unit 200 when the demand predicting/registering unit 110 predicts demand in accordance with the actual demand record. The code storage unit 300 stores the various restriction conditions such as a safety stock and a lead time.

The demand predicting/registering unit 110, data storage unit 200 and code storage unit 300 input the planned demand, inventory information, unit price and the like, and the various restriction conditions to the supply planning unit 120. The supply planning unit 120 outputs supply disabled item information, supply plan information and the like, and information on a planned quantity, an achieved quantity, a unit price and the like. The supply disabled item information is obtained by judgement of whether there is a supply disabled item. If this information exists, it is sent to the delivery time adjusting unit 130, supply disabled reason detecting unit 170 and item importance degree calculating unit 180. The information on the planned quantity, achieved quantity, unit price and the like is sent to the business effectiveness calculating unit 160.

The data storage unit 200 supplies the information on the planned demand, actual demand record and the like to the safety stock checking unit 140. The code storage unit 300 supplies the information on the safety stock, a sample lower limit number and the like to the safety stock checking unit 140. If the check result of the safety stock checking unit 140 indicates that the safety stock can be automatically renewed, e.g., in the case of an item during a stable period, the check result is passed to the safety stock automatic renewal unit 150. If the automatic renewal is not possible, the check result is passed to the item importance degree calculating unit 180. In accordance with the check result, the safety stock automating renewing unit 150 automatically renews the safety stock and stores the renewed safety record in the code storage unit 300. If the automatic renewal cannot be performed, the check result is passed to the item importance degree calculating unit 180. In accordance with the check result, the safety stock automatic renewing unit 150 automatically renews the safety stock and stores the renewed safety stock in the code storage unit 300. Information on the counterplanned safety stock is passed to the item importance degree calculating unit 180. The planned demand and inventory information stored in the data storage unit 200 and code storage unit 300 are passed to the item importance degree calculating unit 180.

The sub-screen generating/processing unit 190 is input with the supply disabled item information and supply plan information from the supply plan making unit 120, the information on an acceptable delivery time from the delivery time adjusting unit 130, the information on a supply disabled reason from the supply disabled reason detecting unit 170, the information on the business effectiveness such as a plan achievement ratio and a sales quantity from the business effectiveness calculation unit 160, and the importance degree ranking information from the item importance degree calculating unit 180. In accordance with this information, the first sub-screen generating/processing unit 190a generates the first sub-screen and the second sub-screen generating/processing unit 190b generates the second sub-screen.

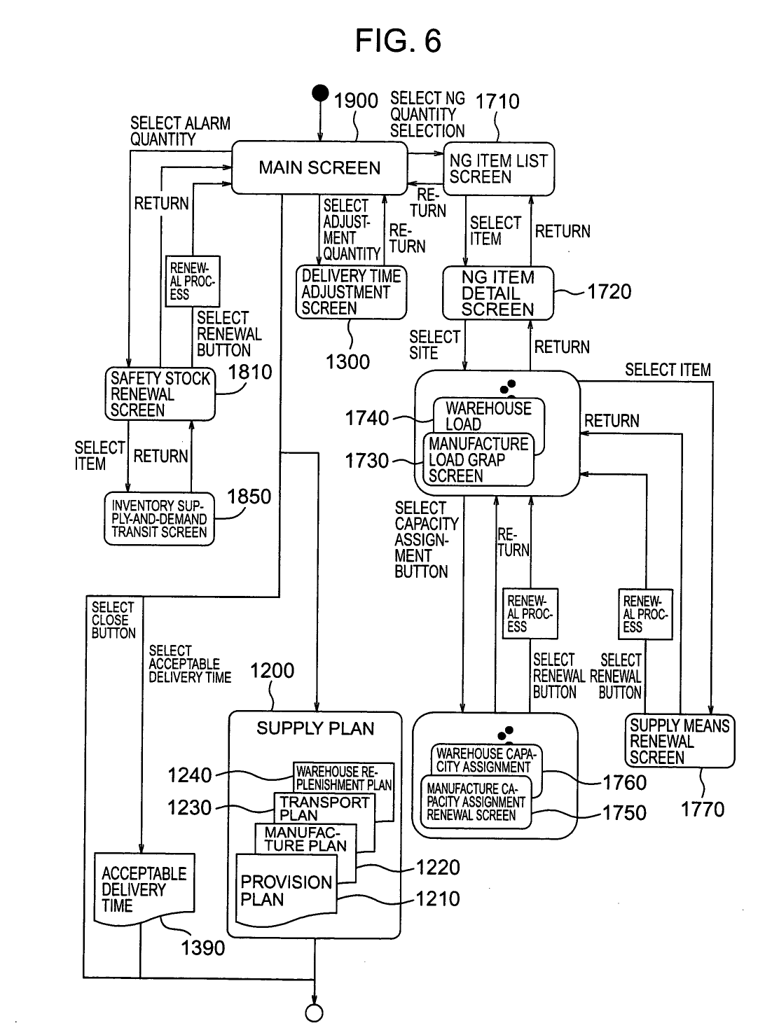

Next, the screen transition which is one characteristic point of the embodiment will be described with reference to FIG. 6. The relation of the screen transition shown in FIG. 6 corresponds to a hyperlink between screens to be described later.

The display contents of each screen are processed and generated by each functional unit of the processing unit 100 shown in FIG. 1. For example, a main screen 1900 is generated by the sub-screen generating/processing unit 190. A supply plan 1200 is created by the sub-screen generating/processing unit 120. A delivery time adjustment screen 1300 and an acceptable delivery time 1390 are processed by the delivery time adjusting unit 130. A safety stock renewal screen 1810 and a inventory supply-and-demand progress screen 1850 are processed by the item importance degree calculating unit 180. An NG item list screen 1710, an NG item detail screen 1720, a manufacture load graph screen 1730, an warehouse load graph screen 1740, a manufacture capacity assignment renewal screen 1750, a warehouse capacity assignment renewal screen 1760 and a supply means renewal screen 1770 are processed by the supply disabled reason detecting unit 170.

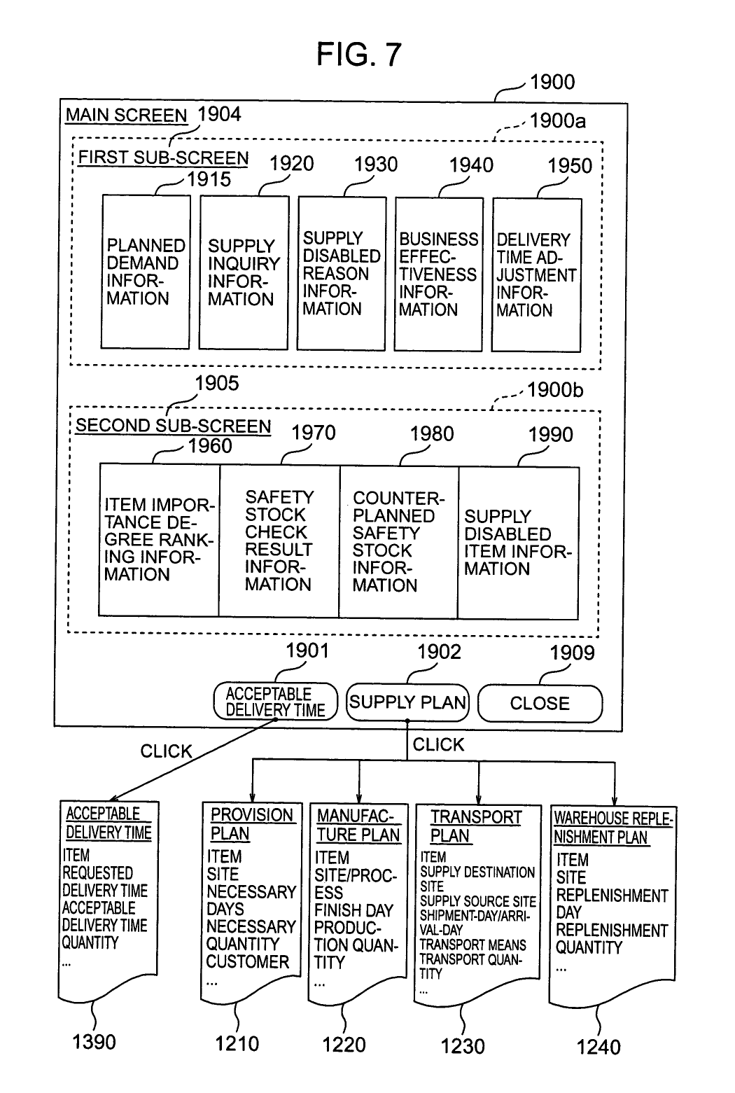

In this embodiment, the main screen 1900 (refer to FIGS. 7, 8, 17, 23, 9, 18 and 24) is made finite. The first and second sub-screens are disposed in the main screen 1900. In response to a selection instruction, the sub-screen generating/processing unit 190 can display the main screen by dividing it into the first and second sub-screens as will be later described. Sequential transition from the main screen 1900, first sub-screen (1900a) and second sub-screen (1900b) to other screens 1710, 1810, 1300 . . . is possible. To this end, each screen has a hyperlink for the transition to another screen.

Sequential transition is possible from the main screen 1900 to the NG item list screen 1710, NG item detail screen 1720, manufacture load graph screen 1730 and warehouse load graph screen 1740. Transition is possible from the manufacture load graph screen 1730 and warehouse load graph screen 1740 to the manufacture capacity assignment renewal screen 1750 and warehouse capacity assignment renewal screen 1760. Transition is also possible from the manufacture load graph screen 1730 and warehouse load graph screen 1740 to the supply means renewal screen 1770. It is also possible to return from each transition destination screen to the transition source screen. Transition from a transition destination screen to another screen is also possible.

Transition from the main screen 1900 to the delivery time adjustment screen 1300 is also possible.

Sequential transition is possible from the main screen 1900 to the safety stock renewal screen 1810 and inventory supply-and-demand progress screen 1820.

When an acceptable delivery time button 1901 on the main screen 1900 is clicked, the delivery time adjusting unit 130 outputs information 1390 on the acceptable delivery time. For example, in this system, printed characters or the like are output. This information is transmitted to the sales site 2. Upon reception of a click of a supply plan button 1902, the supply plan making unit 120 displays or prints the supply plan 1200. The supply plan information and the like are sent to the supply site 4. The supply plan 1200 contains information such as a provision plan 1210, a manufacture plan 1220, a transport plan 1230 and a warehouse replenishment plan 1240. When a close button is clicked, the main screen 1900 is closed.

The display contents of the first and second sub-screens such as shown in FIG. 7 are displayed on the main screen 1900 by the sub-screen generating/processing unit 190. In the example shown in FIG. 7, although only clauses are displayed, the contents of the sub-screens reduced in size may be displayed. The first and second sub-screens are provided with hyperlinks for the transition to the corresponding sub-screens. Disposed in the display area of the first sub-screen is planned supply-and-demand information 1915, supply allocation information 1920, supply disabled reason information 1930, business effectiveness information 1940 and delivery time adjustment information 1950. Disposed in the display area of the second sub-screen is item importance degree ranking information 1960, safety stock check result information 1970, counterplanned safety stock information 1980 and supply disabled item information 1990. Specifically, the number of items corresponding to each ranking is displayed. In addition, the acceptable delivery time button 1901, supply plan button 1902 and close button 1909 are disposed in the main screen.

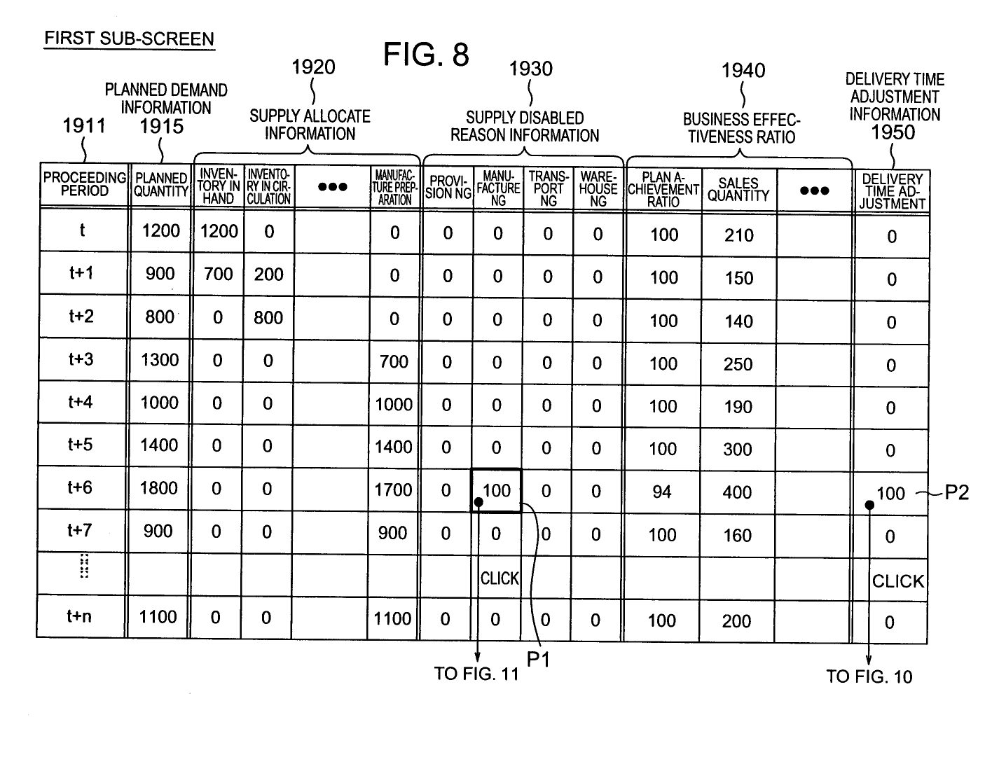

As shown in FIG. 8, the first sub-screen is a screen which displays, in a table format, planned supply-and-demand information 1915, supply allocation information 1920, supply disabled reason information 1930, business effectiveness information 1940 and delivery time adjustment information 1950, respectively for proceeding periods from t to t+n. The supply allocation information may be terms representative of various allocates for supplying products. For example, the supply allocation information includes inventory in hand, inventory in circulation, . . . , manufacture preparation and the like. The supply disabled reason information 1930 is the information on the reason of disabling a supply of products and may be provision NG, manufacture NG, transport NG and warehouse NG. The business effectiveness information 1940 may be a plan achievement ratio and corresponding sales quantity and the like.

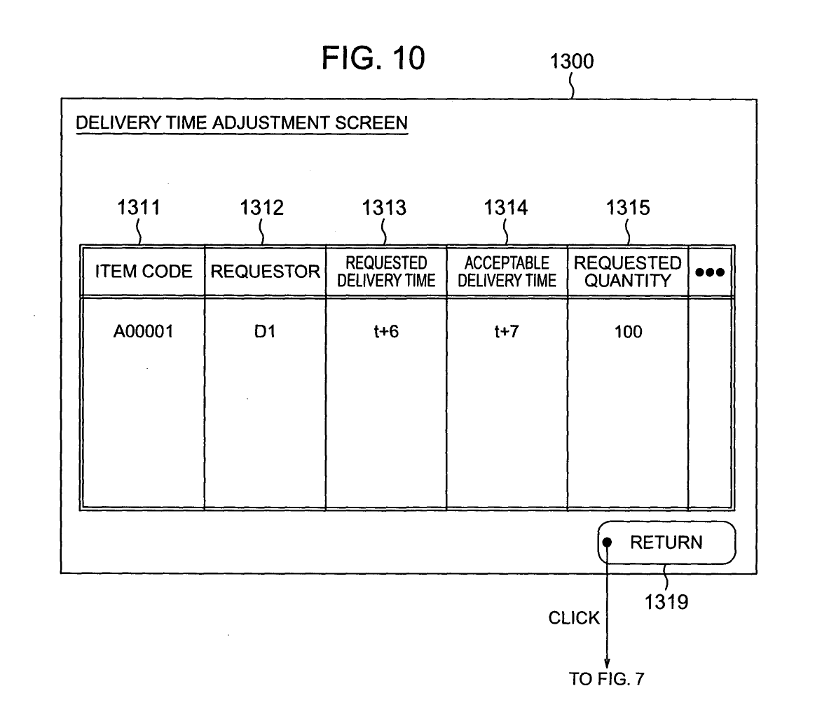

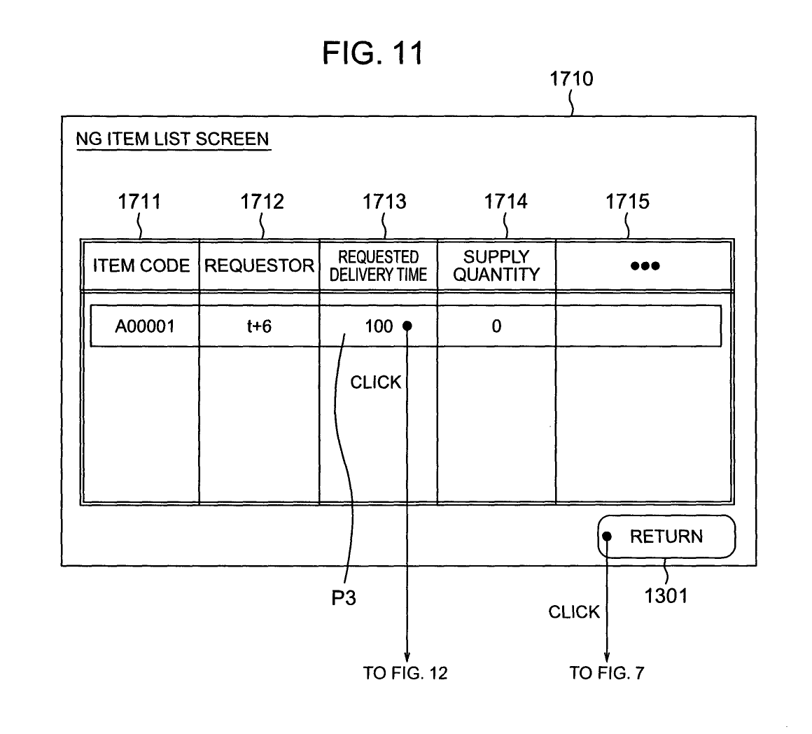

In an area P1 emphatically displayed in a bold frame in the first sub-screen, a total sum of the number of items corresponding to the supply disabled reasons is displayed. In the example shown in FIG. 8, the total sum of items corresponding to the manufacture NG is 100 in the period t+6. This area has a hyperlink to an NG item list screen 1710 shown in FIG. 11. Upon reception of a click via the input device 50, the first sub-screen generating/processing unit 190a makes a transition of the screen to the NG item list screen 1710. A total sum of 100 of the number of items necessary for delivery time adjustment is also displayed in the corresponding period of the delivery time adjustment information. Similarly, upon reception of a click of an area P2, the first sub-screen generating/processing unit 190a makes a transition of the screen to the delivery time adjustment screen 1300 shown in FIG. 10.

FIG. 10 shows in a table format an item code 1311 whose item is subjected to delivery time adjustment, information 1312 on a requester for the product, a requested delivery time 1313, an acceptable delivery time 1314 and a requested quantity 1315. The delivery time adjusting unit 130 searches the period, whose cumulative manufacture time is shorter than the manufacture capacity assignment, after the delivery time indicated by the requested delivery time 1313, to check whether the searched period can absorb the requested quantity. If such a period is found, it is displayed as the acceptable delivery time 1314. In the example shown in FIG. 10, such a period is t+7. If the requested quantity cannot be absorbed by one period, a plurality of periods are searched to check whether the plurality of periods can absorb the requested quantity.

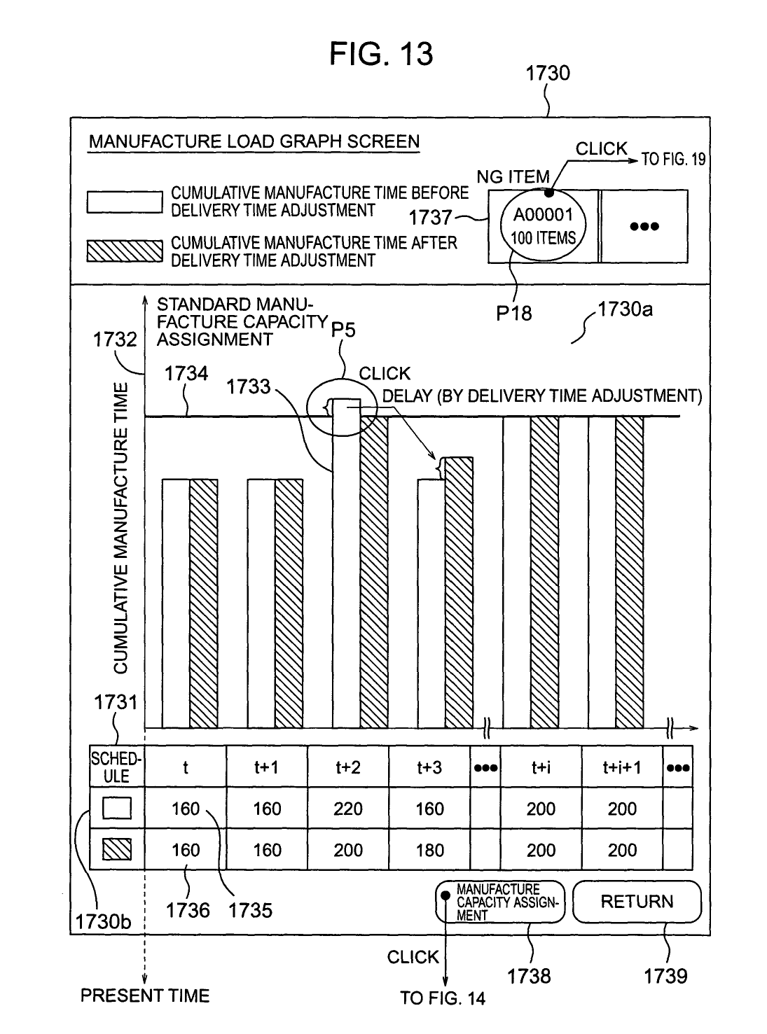

Upon reception of a click of a return button 1319 after the delivery time adjustment, the main screen 1900 shown in FIG. 7 is resumed. The acceptable delivery time is sent to the requestor by the delivery adjusting unit 130 upon reception of a click of an acceptable delivery time button 1901. A bar with hatched lines in a bar graph shown in FIG. 13 indicates delivery time adjustment.

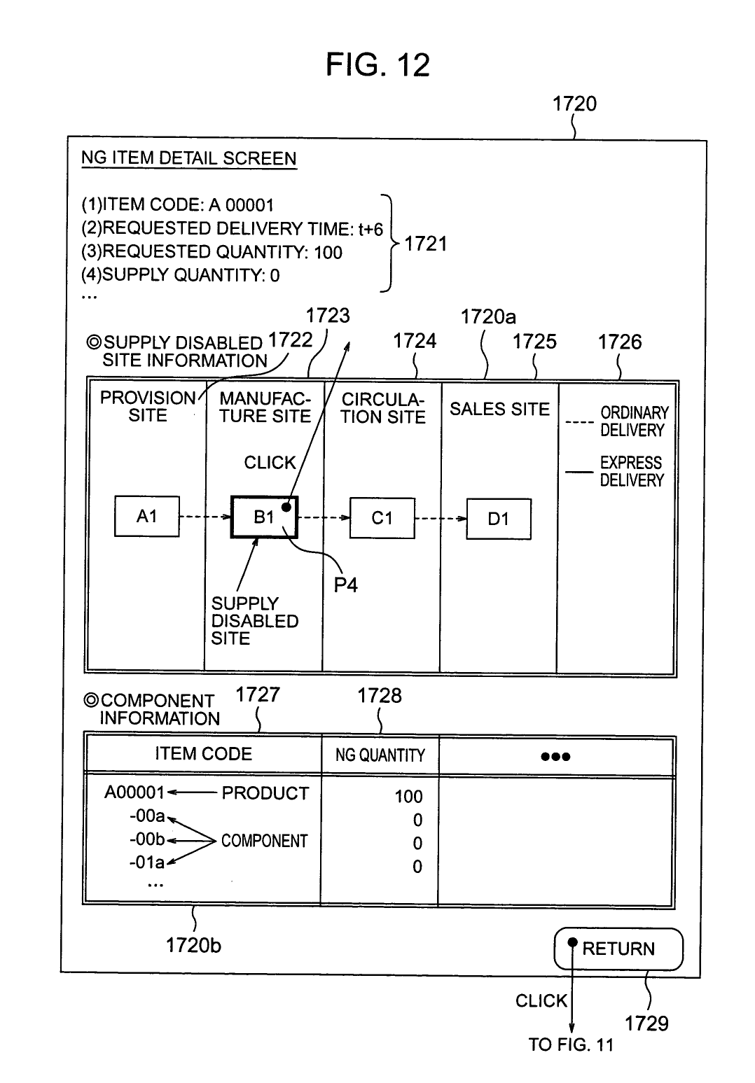

The NG item list screen 1710 shown in FIG. 11 displays in a table format an item code 1711 whose item is a supply disabled item, a requested delivery time 1712 of the item, a requested quantity 1713, a supply quantity 1714 and the like. In the example shown in FIG. 11, a disabled supply occurs only for the item A00001. Upon reception of a click of an area P3 with a numerical value of the requested quantity 1713 in FIG. 11, the supply disabled reason detecting unit 170 makes a transition of the screen to the NG item detail screen 1720 shown in FIG. 12.

FIG. 12 shows the NG item detail screen 1720. Disposed in this screen 1720 are an area 1721 in which data (table in FIG. 11) of the NG Item is displayed, an area 1720a in which supply disabled site information is displayed, and an area 1720b in which component information of the NG item is displayed.

Sequentially disposed in the supply disabled site information area 1720a in accordance with a transfer point of the product are the areas representative of a provision site 1722, a manufacture site 1723, a circulation site 1724 and a sales site 1725. In each of the displayed areas, A1 is a provision site name, B1 is a manufacture site name, C1 is a circulation site name, and D1 is a sales site name. A display indicating a supply disabled site is given in the area of the site where a disabled supply occurs. This area P4 is linked to the manufacture load graph 1730 screen shown in FIG. 13. Upon reception of a click of the area, the supply disabled reason detecting unit 170 makes a transition of the screen to the manufacture load graph screen 1730 shown in FIG. 13.

The manufacture load graph 1730 shown in FIG. 13 is a bar graph indicating a cumulative time of each period as a length of each bar 1733 and having an abscissa 1731 representative of a schedule (from period t, t+1, . . . ) and an ordinate 1732 representative of a cumulative manufacture time of each period. A bar with a white blank indicates a cumulative manufacture time before delivery time adjustment. A bar with hatched lines indicates a cumulative manufacture time after delivery time adjustment. An NG item with its item code and the number of items is displayed in an NG item display area 1737 disposed in an upper side of the screen. Along the abscissa 1731, a cumulative manufacture time is displayed together with the cumulative manufacture times before and after delivery adjustment.

In the schedule period t+2 of this graph, the cumulative manufacture time before the delivery time adjustment is over a standard manufacture capacity assignment 1734. This excessive capacity results in a disabled supply. The disabled supply can be solved in some cases by the delivery time adjustment by the delivery time adjusting unit 130. In the example shown in FIG. 13, the delivery time is adjusted by delaying the delivery time by increasing the number of manufacture items in the proceeding period by the number of manufacture items corresponding to the excessive capacity of the standard manufacture capacity assignment 1734. This method has been described earlier and so the duplicated description will not be made.

In the example shown in FIG. 13, although the delivery time is automatically adjusted, the invention is not limited thereto. For example, by clicking the excessive capacity P5 shown in FIG. 13, the delivery time may be adjusted by delaying the delivery time.

The delivery time adjustment prevents the generation of supply disabled items by delaying the delivery time. Preventing the generation of supply disabled items is not limited thereto. Approaches to other means are shown in FIG. 13. One means is to change means for supplying a product to a requester not to delay a substantial delivery time by delaying the manufacture. Another means is to change the manufacture capacity assignment.

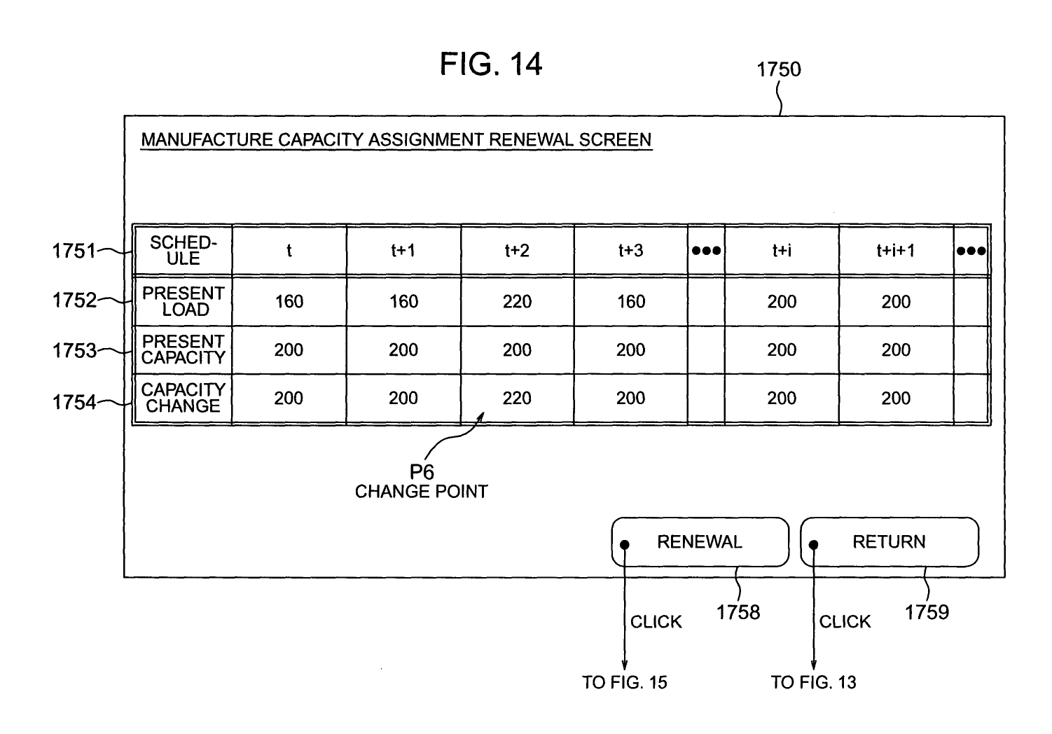

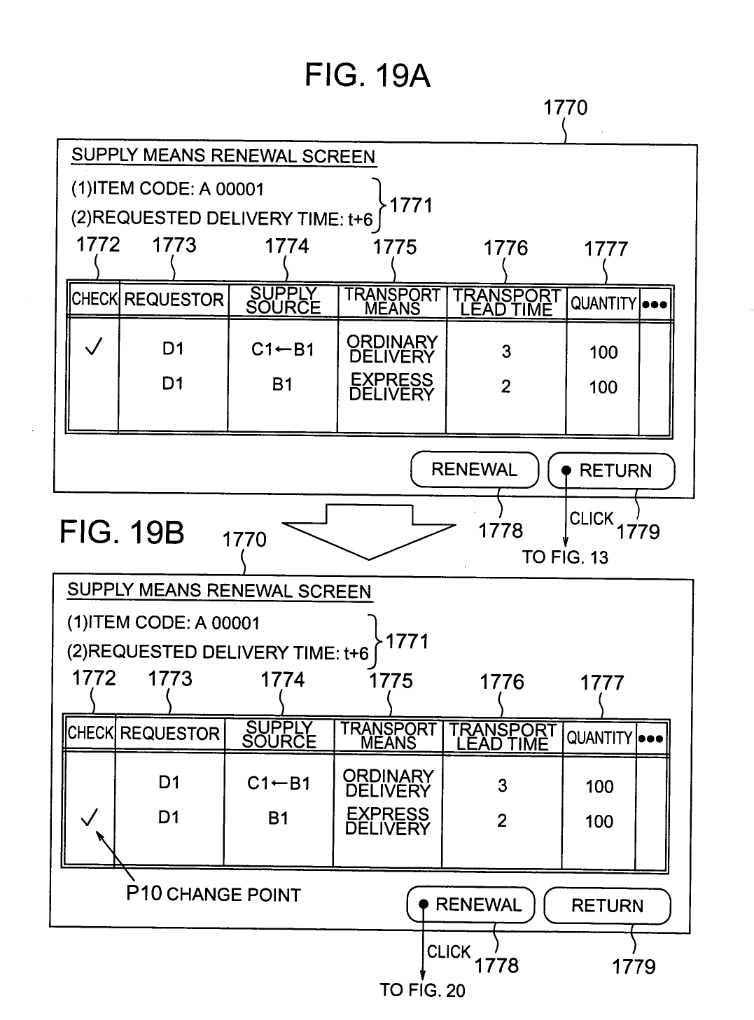

Upon reception of a click of the area P18 shown in FIG. 13, the supply disabled reason detecting unit 170 makes a transition of the screen to the screen shown in FIG. 19A. Upon reception of an instruction to the manufacture capacity assignment button 1738 via the input device 50, the supply disabled reason detecting means 170 makes a transition of the screen to the screen shown in FIG. 14.

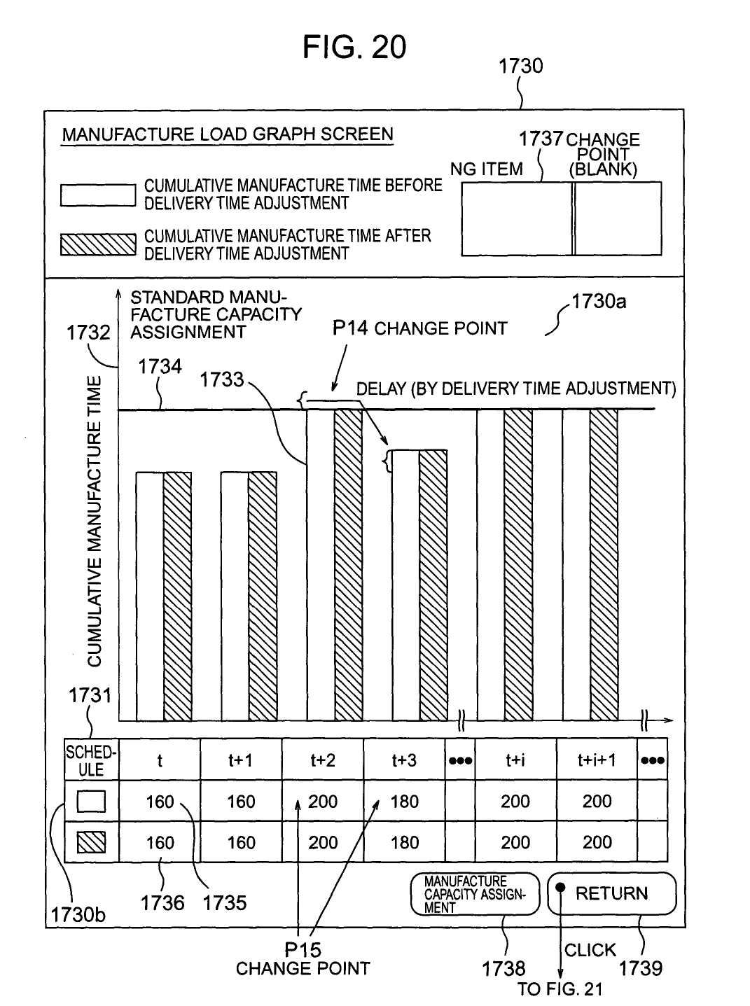

In the screens shown in FIGS. 19A and 19B, a delivery time delay is solved by changing the supply means such as the transport means. In the screen shown in FIG. 19A, means ordinarily used is made valid as the transport means. Means ordinarily used transports a product from the manufacture site B1 to the requestor D1 via the circulation site C1. As shown in FIG. 19B, if means is selected which directly transports a product from the manufacture site B1 to the requester, the lead time reduces from “3” to “2” so that the delivery time delay can be solved during the transport. This selection is performed by receiving a check at a change point P10 in a check column 1772. After reception of such a selection and upon reception of an instruction to a renewal button 1778, the supply disabled reason detecting unit 170 renews the supply means. Namely, part of the supply plan is altered. Transition of the screen to the screen shown in FIG. 20 is made.

As shown in the bar graph of FIG. 20 at a change point P14, although the cumulative manufacture time before the delivery time adjustment in the period t+2 is delayed to the period t+3, one period delay can be solved because the lead time of the supply means is reduced from “3” to “2”. Similarly, the numerical value at a change point P15 is changed.

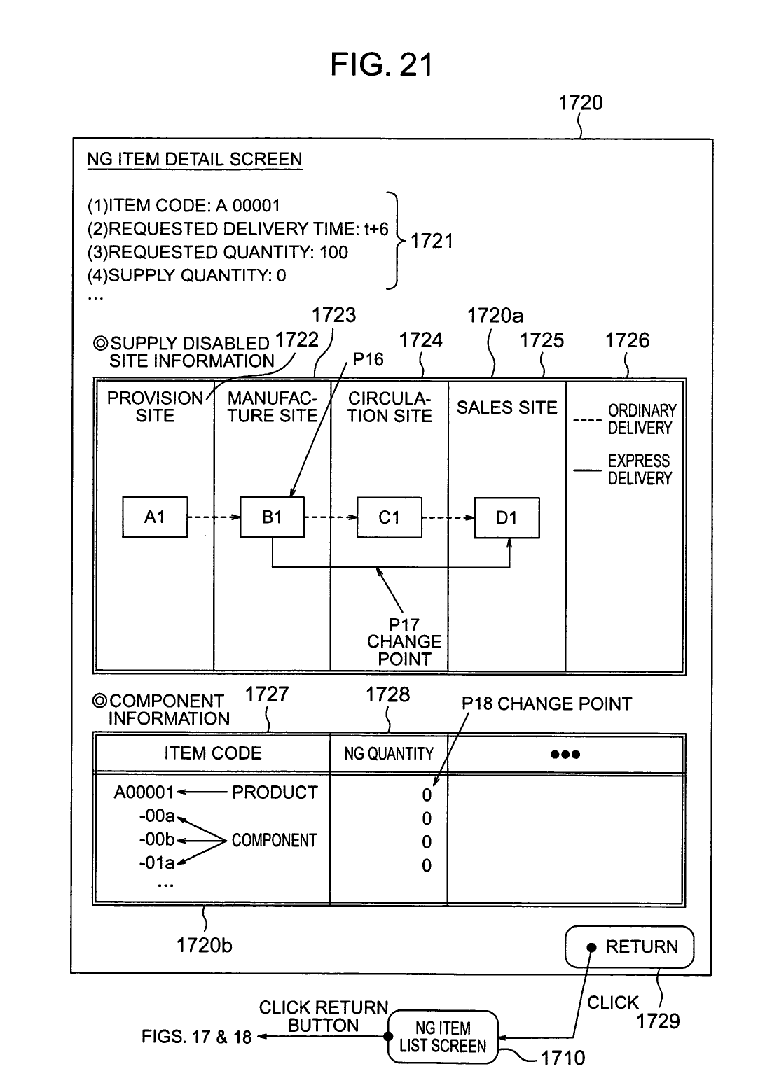

In this state, upon reception of a click of the return button 1739 via the input device 50, the supply disabled reason detecting unit 170 makes a transition of the screen to the NG item detail screen shown in FIG. 21. As shown in FIG. 21, at a change point P16 of the manufacture site 1723 in the supply disabled site information 1720a, the bold frame at the change point P4 before the renewal of the supply means (refer to FIG. 12) was removed. In FIG. 21, an arrow is displayed at a change point P17, directly connecting the symbol of the manufacture site 1723 to the symbol of the sales site 1725. The NG quantity at a change point P18 of the component information 1720b was changed to “0”.

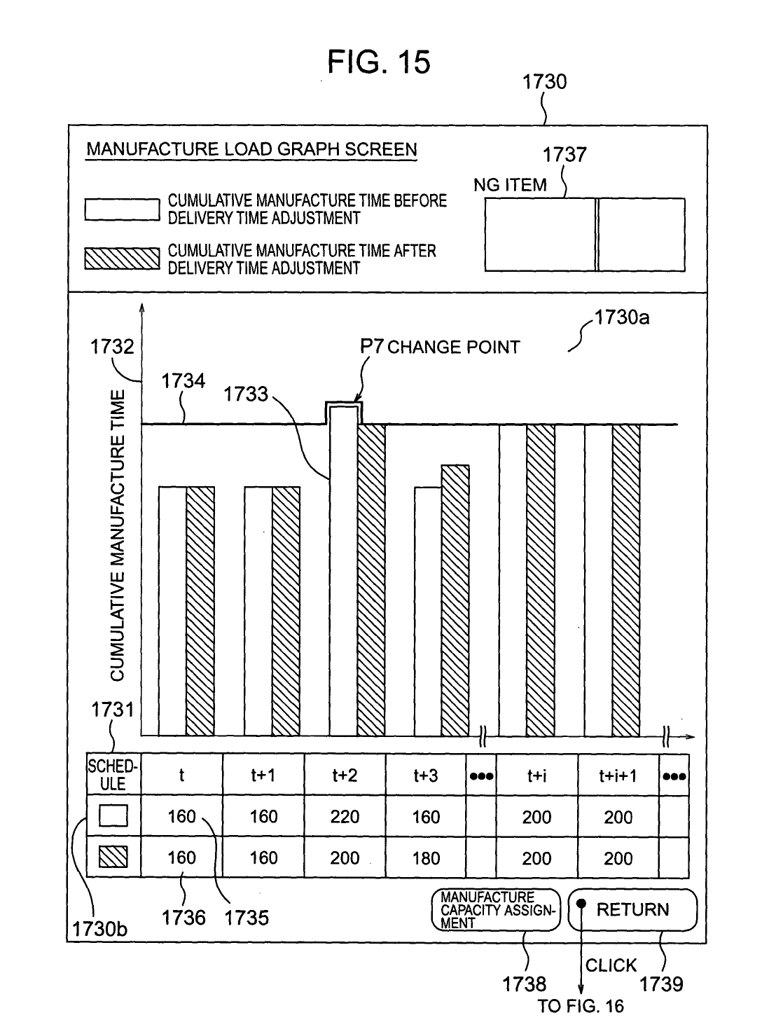

The screen shown in FIG. 14 displays in a table format the manufacture capacity, a present load 1752, a present capacity 1753, a capacity change 1754 in the schedule (from the period t to the period t+i+1) 1751. During the period t+2, an instruction is made to change the capacity from “200” to “220” at a change point P6. Thereafter, upon reception of a click of the renewal button 1758, the supply disabled reason detecting unit 170 makes a transition of the screen to the screen shown in FIG. 15. Upon reception of a click of the return button 1759, transition of the screen to the screen shown in FIG. 13 is made.

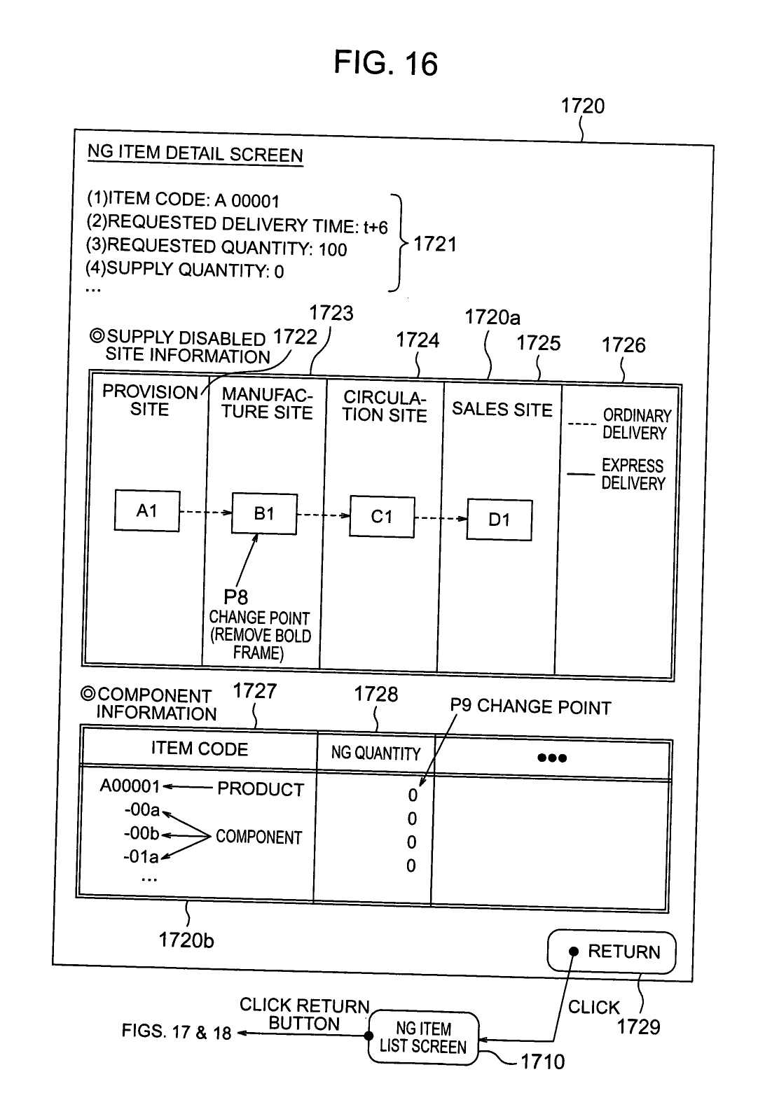

In the screen shown in FIG. 15, although the bar representative of the cumulative manufacture time before the delivery time adjustment in the schedule period t+2 exceeded initially the manufacture capacity assignment 1734 at the area P7, the manufacture capacity assignment 1734 itself changes in the manufacture time increasing direction so that the generation of a supply disabled item can be prevented. Upon reception of a click of the return button 1739, the supply disabled reason detecting unit 170 makes a transition of the screen to the screen shown in FIG. 16.

In the supply disabled site information 1720a of the NG item detail screen shown in FIG. 16, the bold frame (refer to FIG. 12) at the change point P8 due to detection of an existence of a supply disabled item was removed. Namely, it means that the manufacture side 1733 is not in the supply disabled state. Also in the component information 1720b, the numerical value at a change point P9 of the NG quantity was changed to “0”.

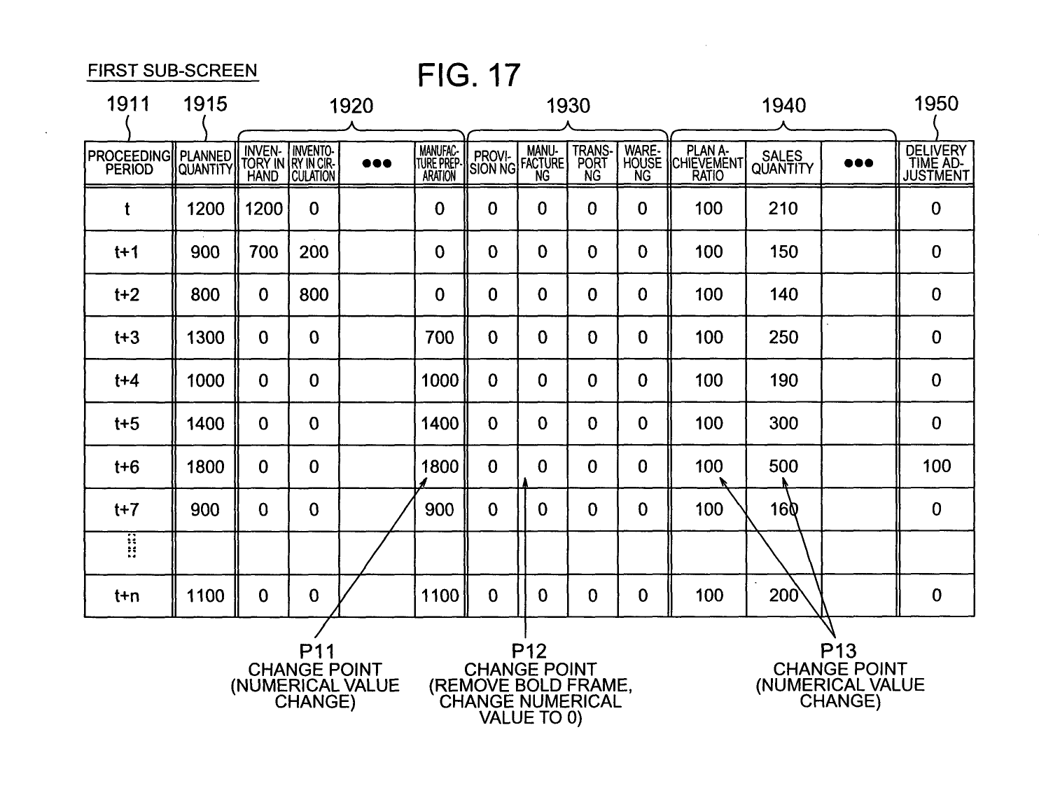

Upon reception of a click of the return button 1729 via the input device 50, the supply disabled item detecting unit 170 makes a transition of the screen to the NG item list screen 1710. Since there is no NG item in FIG. 11, upon reception of a click of the return button 1301, transition of the screen to the first sub-screen shown in FIG. 17 is made.

In the screen shown in FIG. 17, as compared to the first sub-screen shown in FIG. 8, the number of items at the manufacture preparation increases at a change point P11 in supply allocate information 1920 so that the manufacture NG at a change point P12 is changed to “0”. Therefore, a plan achievement ratio at a change point P13 becomes 100% and a corresponding sales quantity increases.

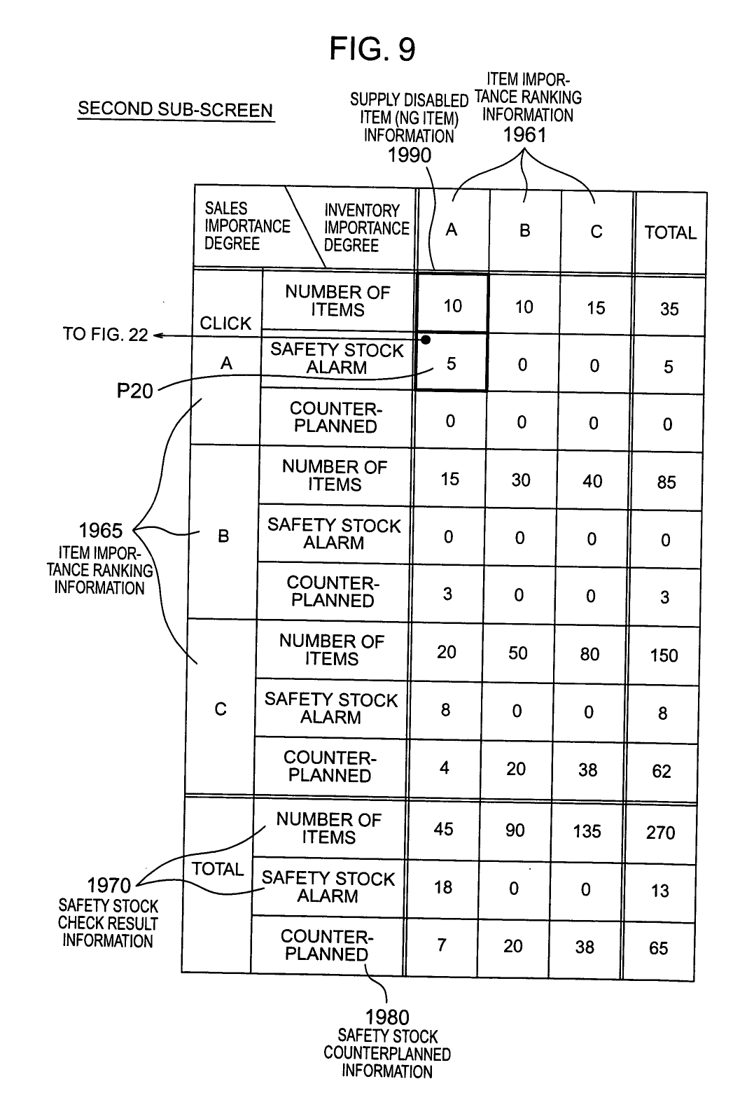

The second sub-screen will be described with reference to FIG. 9. The second sub-screen can be used by judging whether the safety stock is required to be changed.

As shown in FIG. 9, supply disabled item information 1990 is displayed by classifying it by rankings (A, B, C) 1965 based upon item importance degree ranking information of the sales importance degree and by rankings (A, B, C) 1961 based upon item importance degree ranking information of the inventory importance degree. The sales importance degree and inventory importance degree are represented by the (number of items)×(index). For example, the index is a numerical value of a unit price multiplied by an index indicating the importance degree of an item, e.g., a weighting coefficient. Of products and components, some product and component are essential even if they have a low unit price. They have a high importance degree. Some product and component are not essential, although they have a high unit price. The products are therefore ranked in accordance with the importance degree. Rankings A, B and C are represented by %. For example, the ranking A is 80% or higher, the ranking B is from 80% to 95% and the ranking C is 95% or lower.

In the example shown in FIG. 9, the number of items term, a safety stock alarm term and a counterplanned term are classified by the sales rankings. The number of items indicates the number of items belonging to each rank. The safety stock alarm indicates an item whose safety stock is required to be counterplanned. The counterplanned term indicates an item whose safety stock was automatically renewed. These terms correspond to the inventory rankings (A, B, C). For example, an item, if it has a high sales price and the number of items is large, has a high sales importance degree and is ranked to A. An item, even if it has a low sales price or even if the number of items is small, is ranked to A if it has a high importance degree because the index becomes high. An item, if it has a high sales price and the number of stocked items is large, it is ranked to A because the inventory importance degree is high. These rankings are processed by the item importance calculating unit 180.

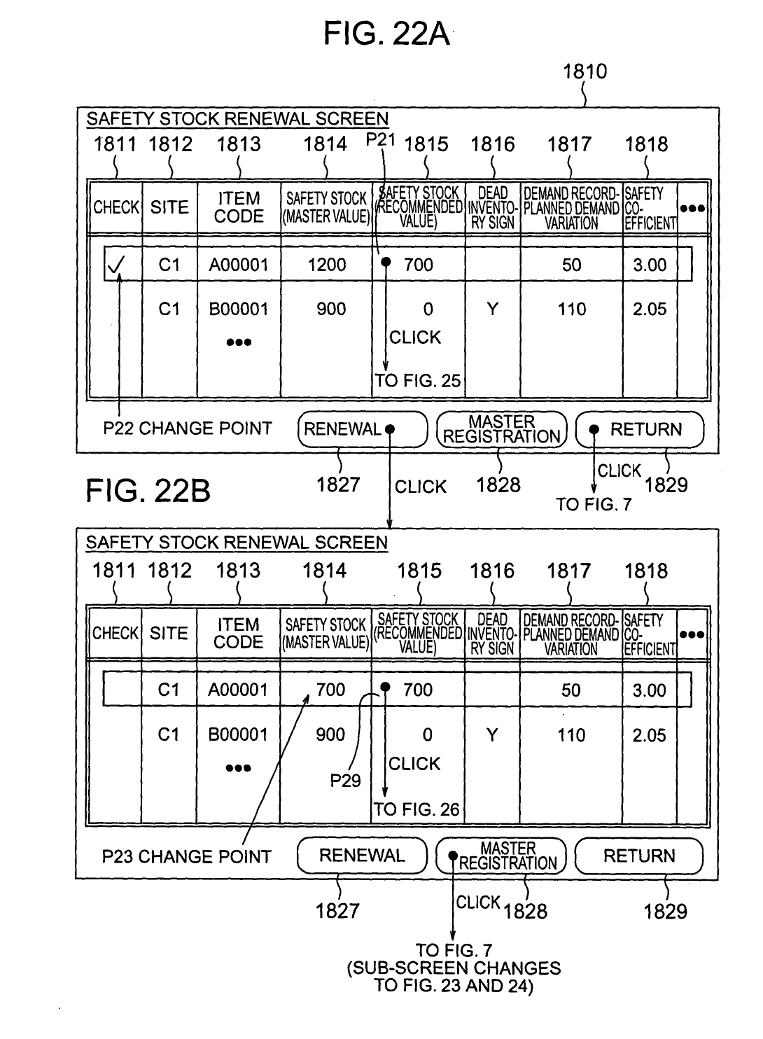

In the state shown in FIG. 9, there are ten items ranked to A in both the sales importance degree and the inventory importance degree. On these ten items, there are five items whose safety stock is required to be counterplanned. An alarm is displayed for the item whose safety stock is to be counterplanned. More in detail, upon reception of a click of a bold frame P20 via the input device 50, the second sub-screen generating/processing unit 190b makes a transition of the screen to the safety stock renewal screen 1810 shown in FIG. 22A.

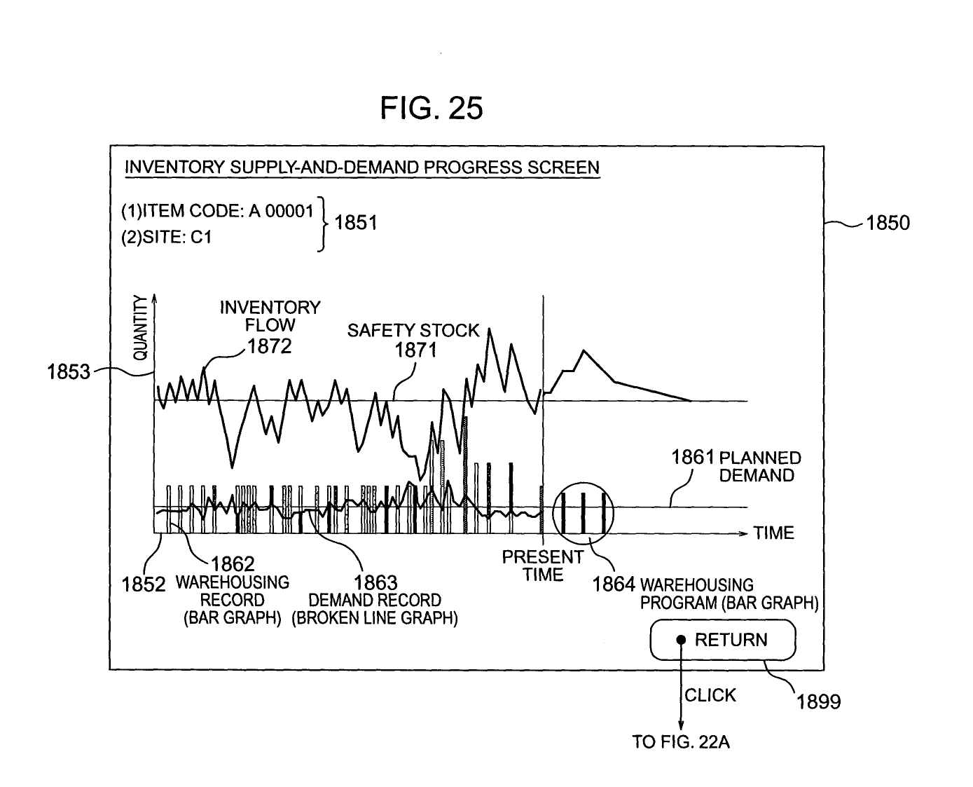

The safety stock renewal screen 1810 displays a site 1812, an item code 1813, a safety stock (master value) 1814, a safety stock (recommended value) 1815, a dead inventory sign 1816, a demand record-planned demand variation 1817 and a safety coefficient 1818, respectively for each item in the area clicked. When a check is entered at a change point P22 in a check column 1811 of an item to be renewed, the corresponding record is selected. In this state, renewal is possible. Upon reception of a click of the selected change point P21 via the input device 50, the item importance calculating unit 180 makes a transition of the screen to the inventory supply-and-demand progress screen 1850 shown in FIG. 25.

The inventory supply-and-demand progress screen 1850 shown in FIG. 25 has an abscissa 1852 representative of time and an ordinate 1853 representative of quantity and time, and sequentially displays a warehousing record bar graph 1862 showing a warehousing record, a demand record broken line graph 1863, a warehousing program bar graph 1864, planned demand 1861, a safety stock 1871 and a inventory flow 1872. It can be seen from the graph that the inventory flow at the present time is greater than the safety stock.

Referring to FIG. 22A, the master value 1814 registered as the safety stock of the selected item is larger than the safety stock (recommended value) 1815 intended not to form lacking items and excessive items. Unnecessary inventory therefore exists. Upon reception of a click of the renewal button 1827 via the input device 50, the item importance degree calculating unit 180 changes the safety stock (master value) 1814 to the same value in the example shown in FIGS. 22A and 22B as the recommended value 1815 dynamically recalculated in accordance with the actual inventory record. At a change point P23 shown in FIG. 22B the master value 1814 is renewed to the same value as the recommended value 1815. In this state, upon reception of a click of the master registration button 1828 via the input device 50, the master value is fetched and registered in the code storage unit 300 as a new safety stock (master value) 1814.

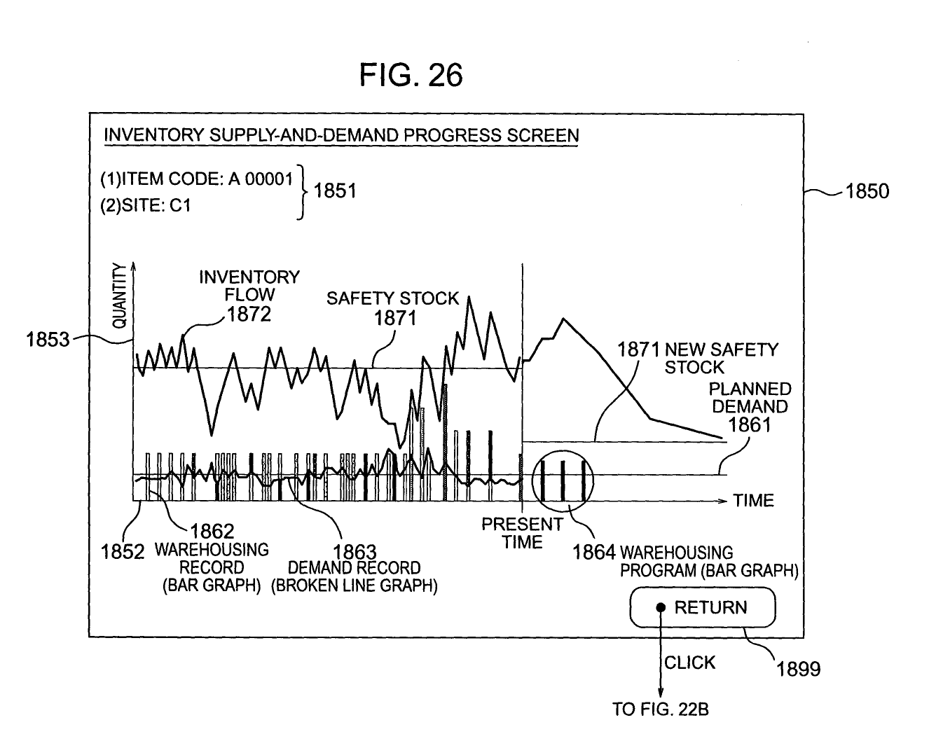

Upon reception of a click of a selected change point P29 via the input device 50, the item importance degree calculating unit 180 makes a transition of the screen to the inventory supply-and-demand progress screen 1850 shown in FIG. 26.

The inventory supply-and-demand progress screen 1850 shown in FIG. 26 has the abscissa 1852 representative of time and the ordinate 1853 representative of quantity and time sequentially displays the warehousing record bar graph 1862 showing a warehousing record, demand record broken line graph 1863, warehousing program bar graph 1864, planned demand 1861, safety stock 1871 and inventory flow 1872. It can be seen from the graph that the safety stock is changed to a new safety stock 1871 at the present time. It can be seen that the inventory flow lowers.

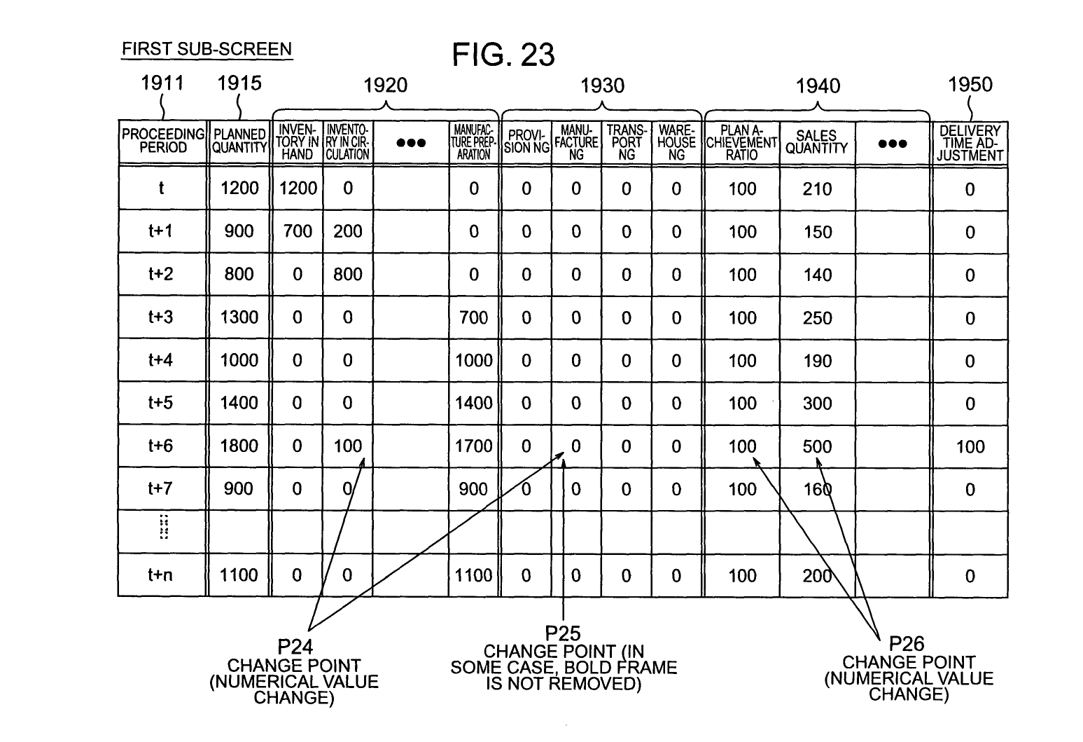

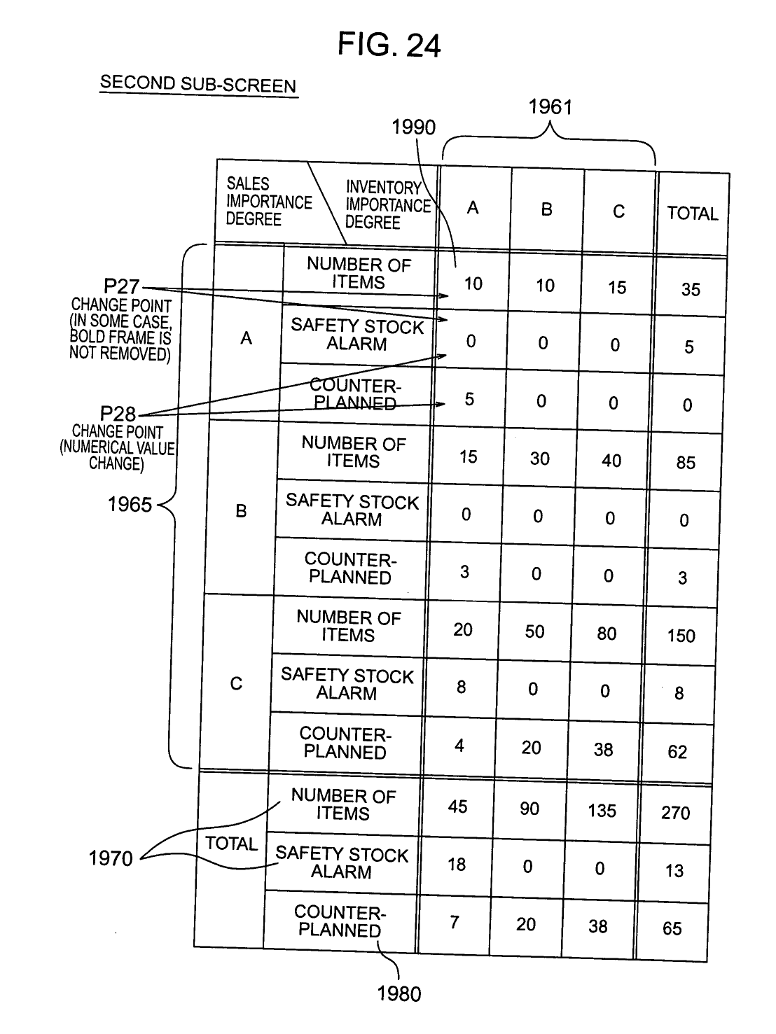

Thereafter, the item importance degree calculating unit 180 makes a transition of the screen to the main screen 1900 (FIG. 7). The contents shown in FIGS. 23 and 24 are reflected upon the contents of the first and second sub-screens. Namely, in the case of FIG. 23, as shown at a change point P24, as the safety stock is reduced, the circulation inventory is inquired so that as shown at a change point P25 the supply disabled item at the manufacture site is “0”. The bold frame is not removed in some cases. In the case of FIG. 24, as shown at change points P27 and P28 in the second sub-screen, the number of items with the safety stock alarm is “0” and the number of counterplanned items is “5”. In the example shown in FIG. 24, although the bold frame of the alarm is removed, it is not removed in some cases.

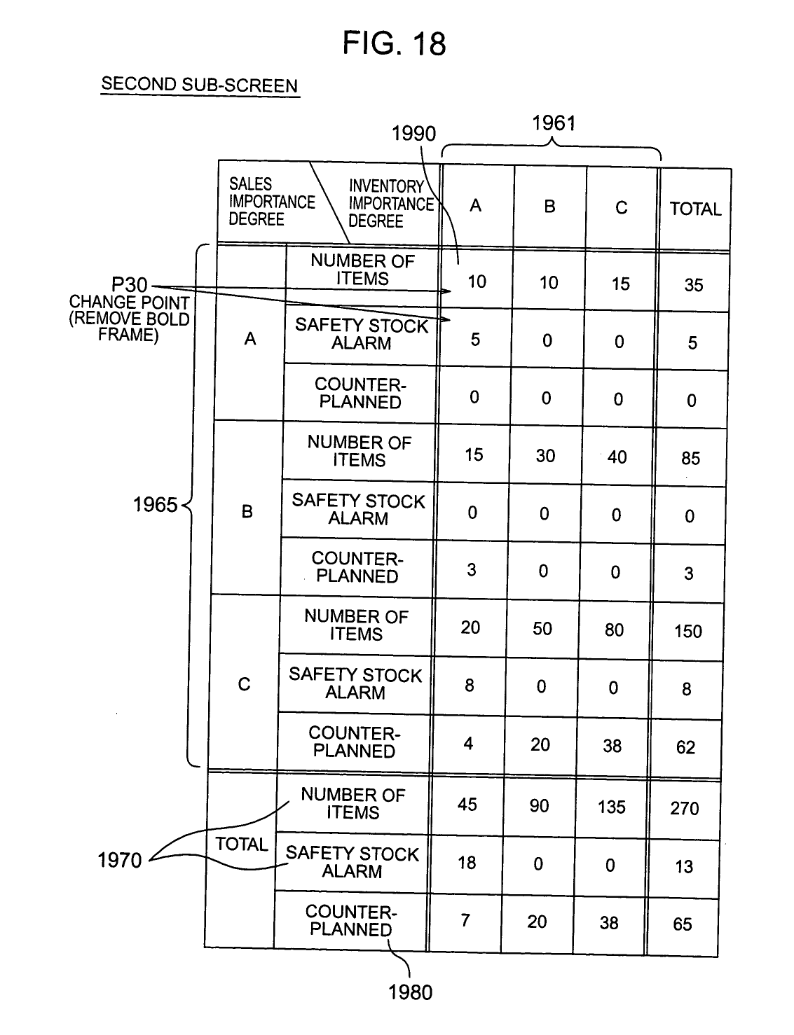

In the case of FIG. 18, when a supply plan is made, processes such as delivery time adjustment and supply means renewal are performed and the alarm is removed at a change point P30 in accordance with the contents of the importance degree ranking.

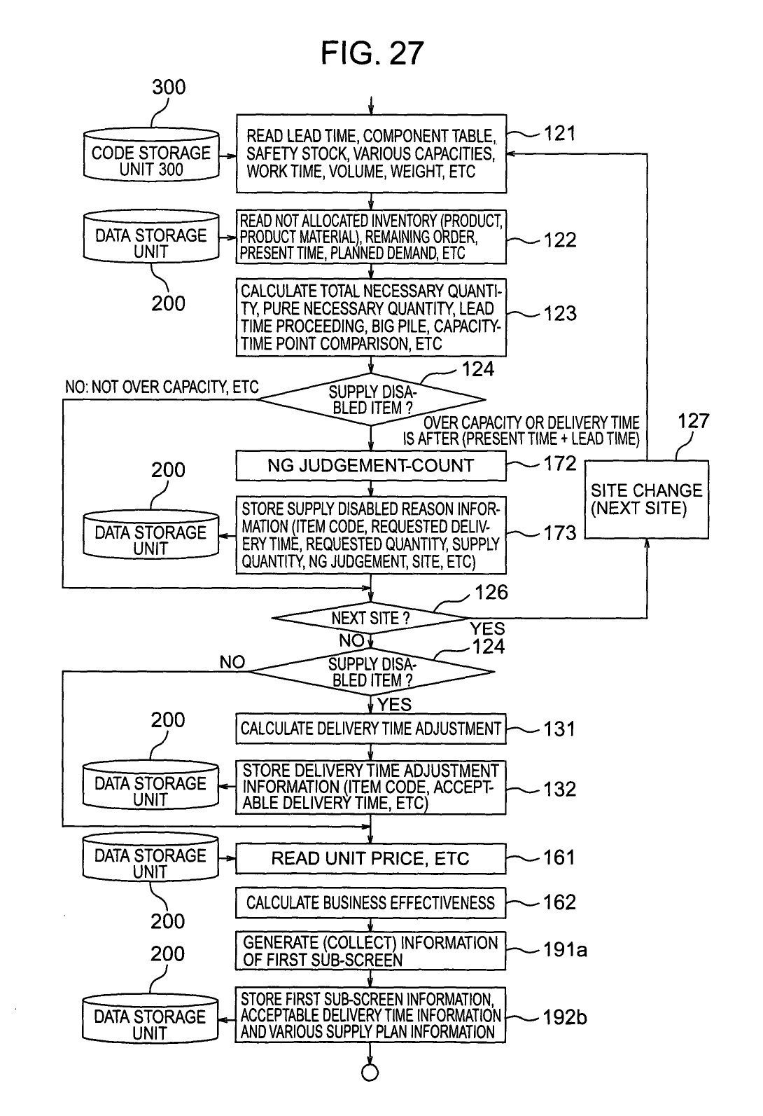

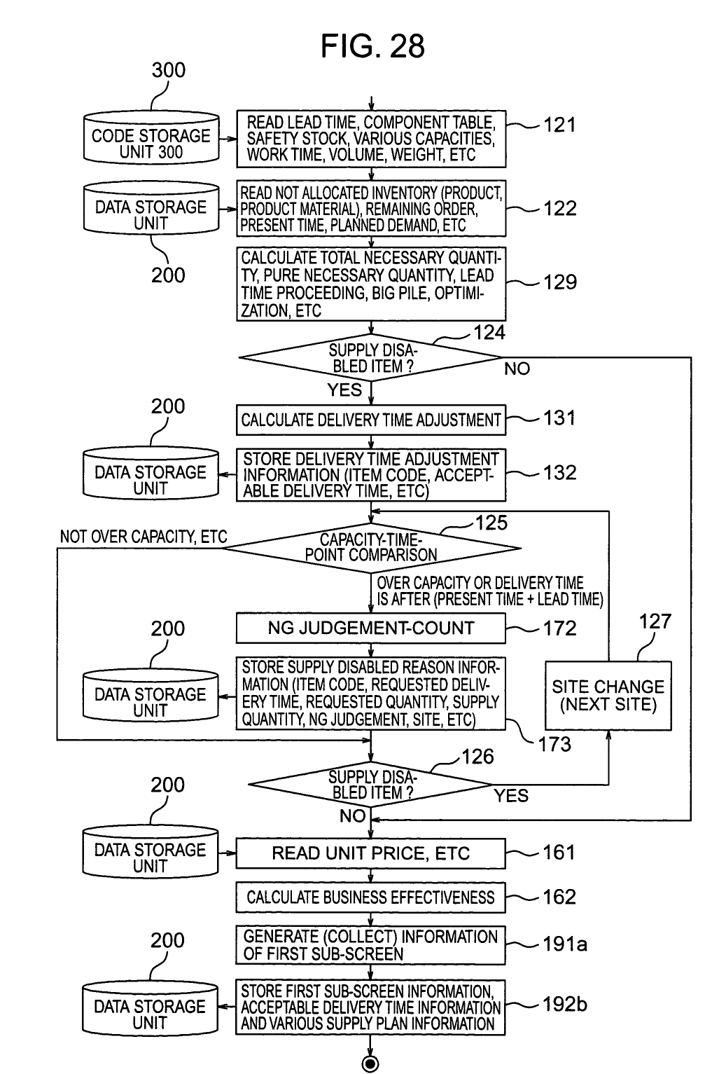

Next, a process of generating the first sub-screen in the system of the embodiment will be described with reference to FIGS. 27 and 28. This process is realized by the various functions of the processing unit 100 shown in FIG. 1. In the present invention, a plurality of sites are in close relation. There is a selection between an independent allocate process and the like to be performed at each site and an integrated allocate process and the like to be performed at all sites in a batch manner. First, a process illustrated in FIG. 27 will be described.

First, the supply plan making unit 120 reads various code data stored in the code storage unit 300. Namely, the supply plan making unit 120 reads a lead time, a component table, a safety stock, various capacities, a work time, a volume, a weight and the like (Step 121). Then, a not-inquired inventory still not inquired as to a product, a product material and the like, a remaining order, time information of a present time, planned demand and the like are read from the data storage unit 200 (Step 121). In accordance with the obtained data and codes, a total quantity of a subject to be processed, a pure total quantity, a lead time proceeding, a big pile, a capacity-time point comparison and the like are calculated (Step 123). It is judged whether a supply allocate process can be performed without an overload of the capacity at the site (Step 124). If the demand does not exceed the capacity, there is no supply disabled item. Then, the next site is processed (Steps 126, 127).

If the demand exceeds the capacity at the site or if the delivery time is nearer to the present time than the present time added with the lead time, because of a short delivery time, there is a supply disabled item.

If there is a supply disabled item, the following process is executed. This process is performed by the supply disabled reason detecting unit 170. First, a judgement (NG judgement) whether there is a supply disabled item is performed and the number of supply disabled items is counted (Step 172). Next, the supply disabled reason detecting unit 170 derives a supply disabled reason by referring to the read item code, requested delivery time, requested quantity, supply quantity, NG judgement result, site and the like, and stores information representative of the supply disabled reason in the data storage unit 200 (Step 173).

The above process is performed for each of all sites (Step 126).

After the process is performed for each of all sites and there is no supply disabled item, the supply plan making unit 120 advances to Step 161, whereas if there is a supply disabled item, a delivery time adjustment is performed (Step 124).

Next, the delivery adjusting unit 130 calculates a delivery time (Step 131). For example, the delivery time calculation is performed by using the following equation.

$${\sum }_{{t}^{′} = 1}^{t} {x}_{{it}^{′}}^{s} = {\sum }_{{t}^{′} = 1}^{t} {D}_{{it}^{′}}^{s} \times {GV}_{1} + {d}_{1 , s , i , t}^{+} - {d}_{1 , s , i , t}^{-} \\ ( i = 1 , … , N , s = R + P + 1 , … , R + P + S , t = 1 , … , T )$$

d⁺_{1,s,i,t}: positive displacement from a target value

d⁻_{1,s,i,t}: negative displacement from a target value

The calculated result, i.e., delivery time adjustment information including an item code, an acceptable delivery time and the like, is stored in the data storage unit 200 (Step 132).

Next, the business effectiveness calculating unit 160 calculates a business effectiveness. In this case, a sales quantity relative to a supply quantity is calculated. To this end, a unit price of each item is read from the data storage unit 200 (Step 161). Next, the business effectiveness, e.g., a sales quantity, is calculated (Step 162).

Next, the first sub-screen generating/processing unit 190a reads the various calculated data from the data storage unit 200 and collects the data of each site and each item (Step 191a). First, sub-screen information to be displayed on the first sub-screen, accepted delivery time information, and various supply plan information is generated and stored in the data storage unit 200 (Step 192a).

With the above processes, information necessary for the display of the first sub-screen is generated. Links are extended between the first sub-screen and associated various screens to facilitate reference to an associated screen.

Next, another process of generating the first sub-screen will be described with referent to FIG. 28. This process is similar to that shown in FIG. 27, excepting that this process is different in that a plurality of sites are processed in a batch manner. Only the different points will be described mainly.

As shown in FIG. 28, first, the supply plan making unit 120 reads a lead time, a component table, a safety stock, various capacities, a work time, a volume, a weight and the like respectively at all sites from the code storage unit 300 (Step 121). Then, a not-inquired inventory, a remaining order, time information of a present time, planed demand and the like are read (Step 122). In accordance with the obtained data and codes, a total quantity of a subject to be processed, a pure total quantity, a lead time proceeding, a big pile, optimization and the like are calculated (Step 129). It is judged whether a supply allocate process can be performed without an overload of the capacity at the site (Step 124). If the demand does not exceed the capacity, there is no supply disabled item. Then, the next site is processed (Step 161).

If the demand exceeds the capacity or if the delivery time is nearer to the present time than the present time added with the lead time, because of a short delivery time, there is a supply disabled item. The delivery time adjusting unit 130 calculates delivery time adjustment and stores the calculation result (Steps 131, 132).

Next, a capacity-time point comparison is performed (Step 125). If the capacity is insufficient, the supply disabled reason detecting unit 170 performs a judgement (NG judgement) whether there is a supply disabled item and counts the number of supply disabled items (Step 172) to derive the supply disabled reason and store the supply disabled reason information in the data storage unit 200 (Step 173). The above processes are performed for all sites (Step 126).

Thereafter, similar to the example shown in FIG. 27, Steps 161 to 192b are executed to generate the information necessary for generating the first sub-screen and stores it in the data storage unit 200.

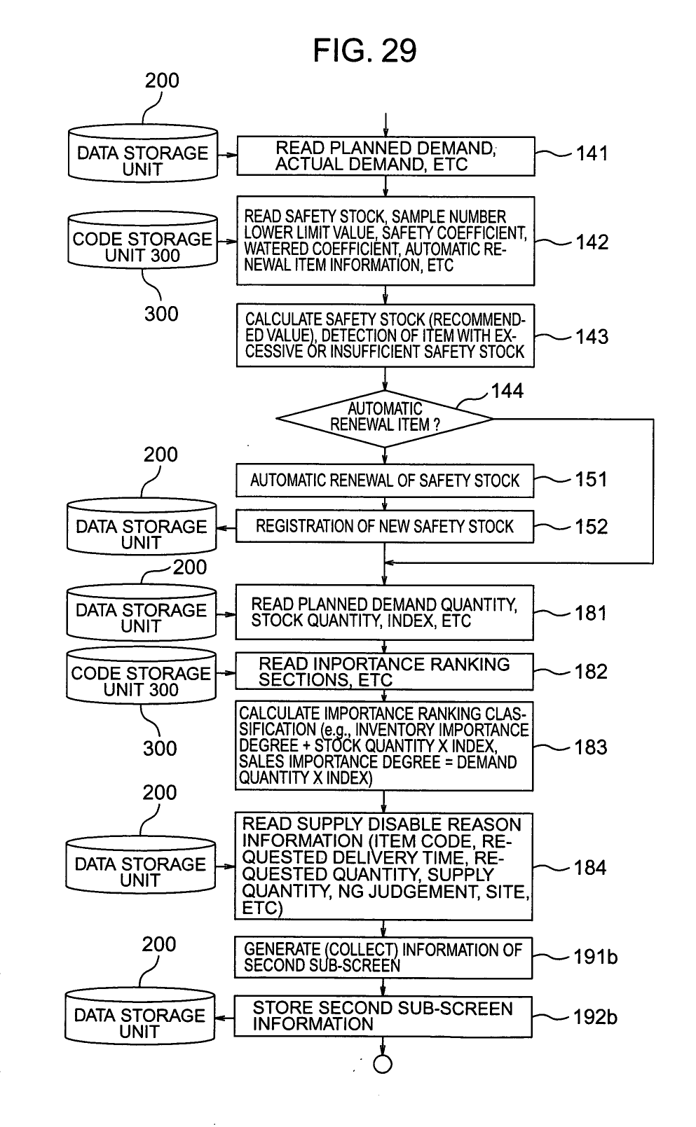

Next, a process of generating the second sub-screen will be described with reference to FIG. 29. The safety stock checking unit 140 of the processing unit 100 reads planned demand, demand record and the like from the data storage unit 200, and further reads a safety stock, a sample lower limit value, a safety coefficient, a watered coefficient, and automatic renewal item information (Steps 141, 142). Then, the safety stock (recommended value), safety stock, excessive and insufficient item detection are calculated and performed (Step 143). It is judged whether the item is to be automatically renewed by reflecting upon the safety stock record, e.g., by using the recommended value (Step 144).

If the item is allowed to be automatically renewed, the safety stock automatic renewing unit 150 calculates the safety stock in accordance with the actual safety stock record (Step 151) and overwrites the previous safety stock with the newly calculated value (Step 152).

The item importance degree calculating unit 180 reads a planned demand quantity, a inventory quantity and an index representative of an importance degree from the data storage unit 200, respectively for an item not subjected to the automatic renewal and an item after the automatic renewal (Step 181). The importance ranking classification and the like are read from the code storage unit 300 (Step 182). Thereafter, the importance ranking is calculated (Step 183).

Next, the supply disabled reason information is read from the data storage unit 200, the information including an item code, a requested delivery time, a requested quantity, a supply quantity, NG judgment, a site and the like (Step 184).

Next, in accordance with the obtained information, data for generating the second sub-screen is collected (Step 191b). The collected second sub-screen information is stored in the data storage unit 200 (Step 192b).

As described so far, according to the embodiment, it is easy to find a supply disabled item and specify the supply disabled reason. It is therefor possible to easily have a countermeasure. By displaying a safety stock, it becomes easy to grasp the safety stock. Since the safety stock is dynamically changed, lacking items are prevented from being generated, and a wasteful inventory can be reduced by quickly matching a product flow. The safety stock can be utilized as effective resources for the means for ensuring a delivery time.

The embodiment system is provided independently from the sales site 3 and various supply sites 4 and is used by the supply-and-demand planner 2. The invention is not limited only thereto. For example, the embodiment system may be separated from a system of the supply-and-demand planner 2, or it may be provided in one of the sales site 3 and various supply sites 4.

The supply-and-demand planning method and system of the embodiment can be run as a business of an independent enterprise. In this case, the supply-and-demand system may take properly one of a charging system based on a data amount, a charging system based on services, and a combination thereof.

The invention provides services of making a supply-and-demand plan among a plurality of sales sites (belonging to different enterprises) and a plurality of supply sites (belonging to different enterprises). In this case, it is easy to find a supply site which can allocate the demand, without changing a delivery time or with a small change thereof. The advantages on the side of a supply site are an effective utilization of resources such as manufacture facilities by providing the sales site side the information representative of a marginal supply capacity the supply site can provide and requesting to find the sales site which uses the marginal supply capacity.

According to the invention, a product supply-and-demand plan can be made quickly and easily for given demand.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A supply-and-demand plan making method of making a supply plan for a manufacture site capable of manufacturing a plurality of items, the supply plan realizing a supply of each item by satisfying a delivery time for planned demand, the method comprising steps of:
comparing a pre-stored manufacture capacity at said site with given demand at each time point, and if a supply disabled item exists, deriving the number of supply disabled items and a time point when a supply becomes disabled and storing the number of supply disabled items and the time point in a storage device as information representative of a supply disabled reason;
displaying, on a display device as a list, planned demand at each of a plurality of proceeding periods, a corresponding supply plan proposal, said site where a supply disabled state occurs, and information representative of a quantity, and displaying said site where the supply disabled state occurs and a supply disabled quantity in the period during which the supply disabled state occurs; and
receiving an external instruction of displaying the supply disabled quantity and displaying information identifying an item constituting the supply disabled quantity and information on a requested delivery time, a requested quantity and a supply quantity respectively of the item.

2. A supply-and-demand plan making method according to claim 1, wherein said supply-and-demand plan is automatically adjusted in accordance with the derived information on the item constituting the supply disabled state and the information of said site where the supply disabled state occurs.

3. A supply-and-demand plan making method according to claim 2, wherein automatic adjustment of said supply-and-demand performs delivery time adjustment.

4. A supply-and-demand plan making method according to claim 2, wherein automatic adjustment of said supply-and-demand receives a change instruction to change supply means for transporting said item from said site to another site and changes said supply means.

5. A supply-and-demand plan making method according to claim 2, wherein automatic adjustment of said supply-and-demand receives a change instruction of changing a manufacture capacity assignment during a proceeding period at said site where the supply disabled state occurs and changes the manufacture capacity assignment during said period.

6. A computer program product for an information terminal which makes a supply plan for a manufacture site capable of manufacturing a plurality of items, the supply plan realizing a supply of each item by satisfying a delivery time for planned demand, the product comprising:
at least one readable medium;
a program code stored in said medium and executed by a processor of said information terminal, said program code comprising steps of:
comparing a pre-stored manufacture capacity at said site with given demand at each time point, and if a supply disabled item exists, deriving the number of supply disabled items and a time point when a supply becomes disabled and storing the number of supply disabled items and the time point in a storage device as information representative of a supply disabled reason;
displaying, on a display device as a list, planned demand at each of a plurality of proceeding periods, a corresponding supply plan proposal, said site where a supply disabled state occurs, and information representative of a quantity, and displaying said site where the supply disabled state occurs and a supply disabled quantity in the period during which the supply disabled state occurs; and
receiving an external instruction of displaying the supply disabled quantity and displaying information identifying an item constituting the supply disabled quantity and information on a requested delivery time, a requested quantity and a supply quantity respectively of the item.

7. A supply-and-demand plan making system for making a supply plan for a manufacture site capable of manufacturing a plurality of items, the supply plan realizing a supply of each item by satisfying a delivery time for planned demand, the system comprising:
means for storing a manufacture capacity of said manufacture site;
means for comparing given demand with the manufacture capacity at each time point, and if a supply disabled item exists, deriving the number of supply disabled items and a time point when a supply becomes disabled and storing the number of supply disabled items and the time point in a storage device as information representative of a supply disabled reason;
means for displaying, on a display device as a list, planned demand at each of a plurality of proceeding periods, a corresponding supply plan proposal, said site where a supply disabled state occurs, and information representative of a quantity;
means for displaying said site where the supply disabled state occurs and a supply disabled quantity in the period during which the supply disabled state occurs; and
means for receiving an external instruction of displaying the supply disabled quantity and displaying information identifying an item constituting the supply disabled quantity and information on a requested delivery time, a requested quantity and a supply quantity respectively of the item.

8. A supply-and-demand plan making system according to claim 7, further comprising supply plan automatic adjusting means for automatically adjusting said supply plan in accordance with the derived information on the item constituting the supply disabled state and the information of said site where the supply disabled state occurs.

9. A supply-and-demand plan making system according to claim 8, further comprising delivery time adjusting means as said supply plan automatic adjusting means.

10. A supply-and-demand plan making system according to claim 8, wherein said supply plan automatic adjusting means automatically adjusts said supply-and-demand plan by changing supply means in accordance with a change instruction to change said supply means for transporting said item from said site to another site, said change instruction having been received via input means.

11. A supply-and-demand plan making system according to claim 8, wherein said supply plan automatic adjusting means automatically adjusts said supply-and-demand plan by changing a manufacture capacity assignment in a proceeding period at said site where the supply disabled state occurs, in accordance with a change instruction to change said manufacture capacity assignment in the proceeding period.
